(19) United States
(12) Patent Application Publication
(10) Pub. No.: US 2024/0369793 A1
(43) Pub. Date: Nov. 7, 2024

(54) MULTILAYER INTERFACE FIBER OPTIC CASSETTE MODULE

(71) Applicant: Panduit Corp., Tinley Park, IL (US)

(72) Inventors: Jose M. Castro, Naperville, IL (US); Thomas M. Sedor, Orland Park, IL (US); Ryan N. Murphy, New Lenox, IL (US); Yu Huang, Orland Park, IL (US); Bulent Kose, Burr Ridge, IL (US)

(73) Assignee: Panduit Corp., Tinley Park, IL (US)

(21) Appl. No.: 18/645,762

(22) Filed: Apr. 25, 2024

Related U.S. Application Data
(60) Provisional application No. 63/463,345, filed on May 2, 2023.

(51) Int. Cl. G02B 6/44

(52) U.S. Cl. CPC G02B 6/4453

(57) ABSTRACT

Apparatuses and methods are provided that relate to the improvement of the interconnection density and cable management of data center fiber optic networks by including a cassette module having a multilayer interface configuration. The cassette modules utilizes depth within an internal space to accomplish the multilayer interface configuration, which results in improved connector density, while maintaining simple connection schemes.

### CROSS-REFERENCE TO RELATED APPLICATION(S)

This application claims benefit to U.S. Provisional Patent Application No. 63/463,345, filed on May 2, 2023, the entirety of which is hereby incorporated by reference herein.

### FIELD OF TECHNOLOGY

Disclosed are apparatuses and methods relating to fiber management cassettes that include features that provide improvements to the interconnection density and cable management of data center fiber optic networks. The disclosed embodiments employ a novel fiber optic cassette module concept that utilizes the internal space within the module to improve the connector density while maintaining simple connection schemes.

### BACKGROUND

Datacenter architectures using optical fiber are evolving to meet global traffic demands and the increasing number of users and applications. The rise of cloud data centers, particularly the hyper-scale cloud, has significantly changed the enterprise IT business structure, network systems, and topologies. In this space, the use of optical fiber for transmitting communication signals has grown rapidly due to its high bandwidth, low attenuation, and other distinct advantages, including radiation immunity, small size, and lightweight.

The overall bandwidth in data centers depends on many factors, such as the data rate per wavelength, the number of wavelengths per fiber, and the number of fibers utilized. All of those parameters have been growing in the last few years. In particular, the significant growth in the number of fiber ports increases the need for more space for active equipment and passive component modules such as cassettes. The larger area not only increases the cost of building, maintaining, and cooling a more extensive infrastructure but also increases the challenges for deploying more powerful edge computing modules.

So, there is a general need from edge to hyper-scale data centers to improve the port density of equipment. In particular, the patch panel and its components, such as racks, chassis, trays, and optical fiber cassettes, are an essential part of the infrastructure. Those passive components can occupy significant space in data centers.

### SUMMARY

Therefore, this disclosure describes a novel optical fiber module that has been configured to overcome density application in data centers by utilizing designs where the front and internal elements of the cassette are provided with optical ports or adapters to enhance the fiber density per area of the same size cassette as known cassettes.

According to an embodiment, a fiber optic cassette apparatus is disclosed which comprises, a main body, a front face, a rear side, a left side, and a right side, with a front face of area Af, that accommodates Na connectors, and has one or more front face openings of total area Ao, with Nl−1 internal layer of optical interfaces, where Nl≥2 and where each layer comprises at least Na adapters or connectors of identical or dissimilar type, each connector with an average area≥Aa and with average Ma fibers, wherein the internal structure of the cassette provides access paths from the front face opening(s) to the internal layers, to patch cords (e.g., optical fiber cable having connectors at both ends) that have an average cross-sectional area, Ac, where Ac/Aa<0.75, for Ac<5 mm, wherein the total area of the aperture is bounded to Na×Ac×(Nl−1)≤Ao<Af, wherein the density measured as the number of connectors or fibers per area Af can be improved by a factor G bounded to 1<G≤Nl/(1+Ac/A_a×(Nl−1)), and wherein the total number of fibers per cassette is given by Nf≥Nl×Na×Ma providing a fiber density of Nf/Af.

According to another embodiment, a fiber optic cassette apparatus is disclosed, which comprises, a main body, a front face, a rear side, a left side, and a right side wherein: the front face accommodates a multiplicity of connectors and has one or more front face openings, the cassette apparatus contains at least one internal layer of optical interfaces, each layer which contains at least one adapter or connector of identical or dissimilar type, the internal structure of the cassette provides access paths from the front face opening(s) to the internal layers for patch cords.

According to another embodiment, a fiber optic cassette is disclosed, which comprises, a main body, a front face, a rear side, a left side, and a right side with a front face of area Af, comprising two layers of optical interconnections, one external accessible from the front face of the module, and another internal, where the first layer accommodates Na1 connectors each with Ma1 fibers, and the second layer Na2 connectors each with Ma2 fibers, where the connectors can be of a similar or different type, and where the front face allocates space for one or two front face openings of total area Ao, wherein the internal structure of the cassette provides access paths from the front face opening(s) to the internal layers, to patch cords that have an average cross-sectional area, Ac, where Ac/Aa<0.5, wherein the total area of the aperture is bounded to Na2×Ac≤Ao<Af, wherein the density measured as the number of connectors or fibers per area Af can be improved by a factor G bounded to 1<G≤2/(1+Ac/A_a)), and where the total number of fibers per module Nf>Na1×Ma1+Na2×Ma2 providing a fiber density of Nf/Af, where the average distance between the first and second layer of adapters is in the range of 70 mm to 125 mm

According to another embodiment, a method and apparatuses are disclosed to increase interconnection density in optical networks using a fiber optic cassette, which comprises, a main body, a front face, a rear side, a left side, and a right side wherein: the front face accommodates a multiplicity of connectors and has one or more front face openings, the cassette apparatus contains at least one internal layer of optical interfaces, each layer which contains at least one adapter or connector of identical or dissimilar type, the minimum distance between two adjacent internal layers is 70 mm, the maximum distance between two adjacent internal layers is 125 mm, the cassette apparatus has one or more front face opening(s) for patch cords, the total area of the front openings is between 8% to 33% of the total front face area of the cassette, the internal structure of the cassette provides access paths from the front face opening(s) to the internal layers of adapters.

According to another embodiment, a fiber optic cassette is disclosed. The fiber optic cassette may comprise a front-side face including a first opening and a second opening, the first opening being a first size and the second opening being a second size, a rear-side wall configured to include a rear opening configured to receive a multi-fiber adapter, a first side wall, a second side wall, a bottom surface floor spanning between the first side wall and the second side wall, a first row adapter configured to install into the first opening, and a second row adapter positioned along a second row on the bottom surface floor.

According to another embodiment, a fiber optic cassette is disclosed. The fiber optic cassette may comprise a front-side face including a plurality of first openings and a second opening, each of the first openings being a first size and the second opening being a second size that is different from the first size, a rear-side wall configured to include a rear opening configured to receive a multi-fiber adapter, a first side wall, a second side wall, a bottom surface floor spanning between the first side wall and the second side wall, a plurality of first row adapters configured to install into the plurality of first openings, and a plurality of second row adapters positioned along a second row on the bottom surface floor.

### BRIEF DESCRIPTION OF THE DRAWINGS

FIG. 1A illustrates a front-side view of a known cassette module.

FIG. 1B illustrates a top-down view of the known cassette module shown in FIG. 1A.

FIG. 1C illustrates a front-side view of an exemplary fiber optic cassette module, according to an embodiment.

FIG. 1D illustrates a top-down view of the exemplary fiber optic cassette module shown in FIG. 1C, where a first set of ports are populated with fiber optic connections, according to an embodiment.

FIG. 1E illustrates a top-down view of the exemplary cassette module shown in FIG. 1C, where a second and third set of ports are populated with fiber optic connections, according to another embodiment.

FIG. 2A illustrates a top-down view of a known cassette module.

FIG. 2B illustrates a top-down view of an exemplary fiber optic cassette module, according to an embodiment.

FIG. 3A illustrates a perspective view of the fiber optic cassette module shown in FIG. 2B.

FIG. 3B illustrates a top-down view of the fiber optic cassette module shown in FIG. 2B.

FIG. 3C illustrates a side view of the fiber optic cassette module shown in FIG. 2B.

FIG. 3D illustrates a top-down view of the fiber optic cassette module shown in FIG. 2B, where a top cover has been removed.

FIG. 4A illustrates a perspective view of a fiber optic cassette module, according to an alternative embodiment.

FIG. 4B illustrates a top-down view of the fiber optic cassette module shown in FIG. 4A.

FIG. 4C illustrates a side view of the fiber optic cassette module shown in FIG. 4A.

FIG. 4D illustrates a top-down view of the fiber optic cassette module shown in FIG. 4A, where a top cover has been removed.

FIG. 5A illustrates a perspective view of the fiber optic cassette module shown in FIG. 4A.

FIG. 5B illustrates a perspective view of the fiber optic cassette module shown in FIG. 4A, where a tilting feature is being used according to some embodiments.

FIG. 5C illustrates a perspective view of the fiber optic cassette module shown in FIG. 4A, where a tilting feature is being used and where a top cover is removed to show an interior portion according to some embodiments.

FIG. 5D illustrates a side view of the fiber optic cassette module shown in FIG. 4A, where a tilting feature is being used according to some embodiments.

FIG. 6A illustrates a magnified view of a portion from the fiber optic cassette module shown in FIG. 5A that includes a pivotable feature, where the pivotable feature is in a non-tilted state according to some embodiments.

FIG. 6B illustrates a magnified view of a portion from the fiber optic cassette module shown in FIG. 5A that includes a hinge feature, according to some embodiments.

FIG. 6C illustrates the magnified view showing the pivotable feature from the cassette module shown in FIG. 5A, where the pivotable feature has been rotated up to a tilted state according to some embodiments.

FIG. 6D illustrates a magnified view of a portion from the fiber optic cassette module shown in FIG. 5A that includes a latch feature, according to some embodiments.

FIG. 7A illustrates a top-down view of an exemplary fiber optic cassette module using smaller form factor adapters, according to an alternative embodiment.

FIG. 7B illustrates a top-down view of an exemplary fiber optic cassette module using smaller form factor adapters, according to an alternative embodiment.

FIG. 7C illustrates a mess circuit connection scheme of an exemplary fiber optic cassette module using smaller form factor adapters, according to an alternative embodiment.

FIG. 8A illustrates a top-down view of an exemplary fiber optic cassette module configured to utilize asymmetric openings, according to an alternative embodiment.

FIG. 8B illustrates a top-down view of an exemplary fiber optic cassette module configured to utilize a wider physical width and internal adapters, according to an alternative embodiment.

FIG. 9A illustrates a top-down view of an exemplary fiber optic cassette module including an additional fiber optic component, according to some embodiments.

FIG. 9B illustrates an exemplary fiber component that may be utilized inside the fiber optic cassette module shown in FIG. 9B, according to some embodiments.

FIG. 10A illustrates a top-down view of an exemplary enclosure for holding and managing a plurality of fiber optic cassette modules, according to some embodiments.

FIG. 10B illustrates a top-down view of the enclosure shown in FIG. 10A, where the enclosure includes a tray in an extended-out state, according to some embodiments.

FIG. 10C illustrates a top-down view of a tray included in the enclosure shown in FIG. 10A, where the tray is holding fiber optic cassette modules, according to some embodiments.

FIG. 10D illustrates a top-down view of the tray shown in FIG. 10C, where at least one fiber optic cassette module is being released from the tray, according to some embodiments.

### DETAILED DESCRIPTION

The deployment of 1.6 Tbps per transceiver module over a duplex optical fiber can be foreseen for use in datacenter networks. This significant increase in bandwidth per fiber as well as the release of new high-density connectors such as SN, MDC, MMC, or SN-MT can enable bandwidth densities of Petabit per second (Pbps) per rack unit (RU) in a 19-inch rack width.

Prior art cassettes, designed when the transceivers operated at 10 Gbps or 40 Gbps, have limited bandwidth densities since the number of connectors is proportional to the front face area of the cassettes. Due to this constraint, those prior art cassettes cannot provide the high bandwidth densities needed in future data centers. Therefore, this disclosure describes a novel optical fiber module that has been configured to overcome density application in data centers by utilizing designs where the front and internal elements of the cassette are provided with optical ports or adapters to enhance the fiber density per area of the same size cassette as currently available cassettes.

Certain known fiber optic cassettes and systems for fiber optic cable management include high-density apparatuses for optical patching comprising chassis and optical modules and claimed high density (e.g., 144 fibers/RU). However, such known apparatuses denoted here as traditional cassette modules, may only place the optical adapters in the front face of the cassette, which physically constrains its interconnection density. So, in these existing cassettes, the interconnection density is dominated by the ratio of areas between the front face and the optical adapter.

Other known fiber optic cable management systems that may offer more efficient use of the space include systems where a tray has optical connectors directly mounted into itself. In these systems, the patch ports are arranged along a horizontal plane or a tray, which takes advantage of the depth of the cabinet for patching. The patch port openings are placed perpendicular or tilted relative to the surface tray. The disclosed tray is movable and positioned within a cabinet enclosure. However, even though these systems may provide a larger number of connections than previous approaches, it also increases the challenges for installation and deployment for various reasons.

For one, the tray depth requires that the patch cords have significantly different lengths, which increases the complexity of ordering parts and managing the stock. Alternatively, one type of patch cord, the longest that can reach the farthest connector in the tray, can be used. However, that requires stocking a large variety of patch cable lengths. Another challenge in that prior art is that the cables have to be routed using horizontal and vertical directions. Moreover, the flexibility to add or remove is compromised and becomes more complex as the number of connectors on the tray increases. In practice, in a highly populated tray, it is challenging to update the connection without disrupting neighboring cables or ports.

So due to the growth of optical interconnections in data centers, it is desirable to increase the front-face density of optical modules and cassettes without increasing the complexity of the structured cabling. Also, it may be more desirable to operate a cable management system comprised of optical modules and cassettes, instead of just trays, to provide more flexible deployment options and upgrades to the network.

It follows that the present disclosure describes exemplary apparatuses, systems, and methods for achieving this objective that overcome the challenges described above.

Currently, the interconnection density of structured cables using cassette modules depends on the ratio of areas between adapters on the cassette front face and a width of the cassette front face. The disclosed solution is a fiber optic cassette module that increases the density by adding more connector/adapter interfaces in the internal space of a cassette, with access to that space added via openings in its front face. This concept, named here as multilayer interfaces with the opening, capitalizes on the low ratios between patch cords and adapters cross-sectional areas. The low ratios make it advantageous to replace some adapters or connectors of the front face with one or more front side openings which are designed to route patch cords to adapters inside the cassette module that provide greater connection density than what would traditionally be enabled through the front side openings. It will be shown in this document that in the multilayer interfaces with the opening concept, the interconnection density is no longer dominated by a simple ratio of areas between the front face and adapters. Two more parameters such as the cassette depth and patch cross-sectional cord area can now be used to further increase the interconnection density.

Moreover, the concept of using openings in the front face to route patch cords entirely avoids the need to route cables above the height of the cassette, which is a practiced feature of some of the existing cassette designs. Therefore, cassettes can not only improve higher density but enable a smaller height form factor, e.g., using cassettes and adapter heights, which improves the handling and modularity of the cassette. A modular form factor cassette system is desirable to scale the structured cabling of data center networks.

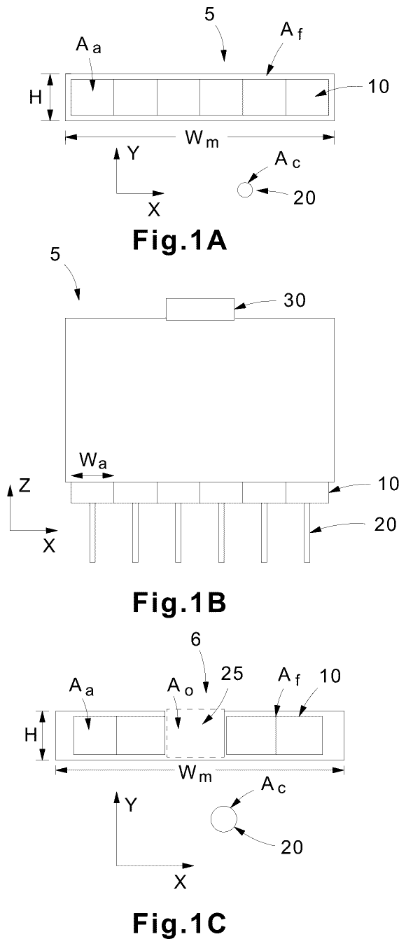

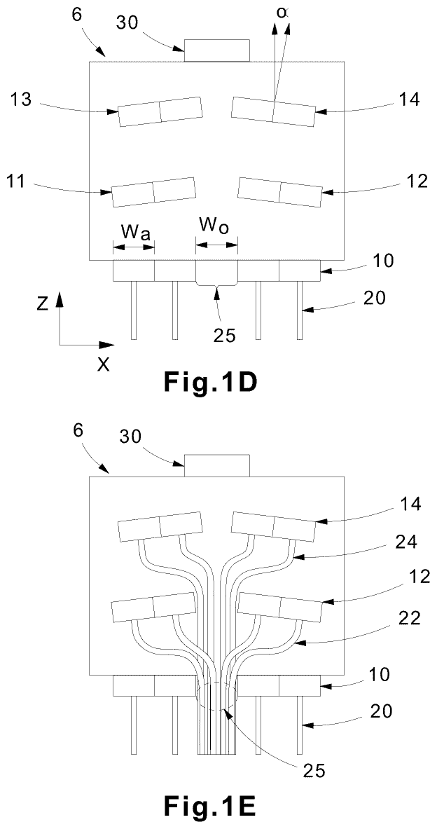

FIGS. 1A-1E illustrate the multilayer interface with the opening concept of the novel cassette module being disclosed herein and compares it with an exemplary known cassette module 5. FIG. 1A shows a front view, {X, Y}, of the exemplary known cassette module 5 including six adapters 10, each of the adapters 10 having an area Aa. In the figure, Af represents the total area of the cassette, as calculated by Af=Wm×H, where Wm is the cassette width, and H is the cassette height. For exemplary purposes, here we assume Aa≈Wa×H, where Wa is the adapter width. A cross-section view of a patch cord 20 is shown and its cross-sectional area is denoted by Ac.

FIG. 1B shows a top view, {X, Z}, schematic of the same known cassette module 5, with six patch cords 20 connected to the cassette adapters 10, where the cross-sectional area Ac of the patch cord 20 is shown in FIG. 1A. On the rear side of the known cassette module 5, there is a multifiber adapter or connector 30. For exemplary purposes, it may be assumed that the density of the known cassette module 5 is already fully optimized. This means the height of cassettes and adapters are almost similar, and the area occupied by the Na=6 adapters is almost equal to the total area of the known cassette module 5, Af≈Na×Aa.

FIG. 1C shows a front view, {X, Y}, of an exemplary embodiment of the disclosed cassette 6 including the multilayer interface with the opening cassette module, where the cassette is also shown to include four external adapters 10. For a fair comparison, this cassette 6 has identical width and height to the known cassette module 5 and the used adapters 10 also have an identical area Aa, to the known cassette module 5.

A noticeable difference between the current cassette 6 and the known cassette module 5 is the opening 25, which in the embodiment displayed in FIGS. 1C-1E, is a front face opening with an area Ao positioned in the middle of a front face of the cassette 6. As shown in FIG. 1C, Ao≈Wo×H, where Wo is the width of the front face opening 25 located at the center of the cassette 6, and H is the height of the cassette 6. FIG. 1D shows a top view {X, Z} of the cassette 6, which further displays two more internal layers of adapters/connectors 11, 12, 13, and 14, where each of the adapters/connectors 11, 12, 13, and 14 include two adapters (i.e., duplex), a major difference from the known cassette module 5 which places all the adapters 10 only on the front face. Note that the adapters 11, 12, 13, and 14 in each layer inside the cassette 6 may be oriented with different angles to optimize space or to facilitate access of patch cords 22, 24 from the opening 25 to the internal layers of interfaces 11, 12, 13, and 14. For example, in FIG. 1D, the adapters/connectors 14 are tilted, by an angle, α, relative to the Z-axis. FIG. 1E shows the same top view of the cassette 6, with the addition of patch cords 22, 24 being routed to the different interfaces 11, 12, 13, and 14 at their respective layer, where the patch cords 22 and 24 passes through the opening 25 to connect to the internal layers of the interfaces 11, 12, 13, and 14.

The interconnection density, Do, of, for example, the known cassette module 5 is given by:

$$Do = Na / {A}_{f} , \qquad ( 1 )$$

where Na is the number of adapters/connectors in the front face of known cassette module 5, and Na≤Af/Aa.

On the other hand, the interconnection density, D, of the multilayer interface cassettes described herein is given by:

$$D = {Na}^{′} / Af = G \times Do , \qquad ( 2 )$$

where Na′ is the number of adapters/connectors in each layer of cassette 6, and G is a density gain factor. Note that Na′≤Na since some area from the front face needs to be allocated for the opening, producing an effective front face area of, Af-Ao.

Under those conditions, G can be derived as,

$$G = Nl / ( 1 + \frac{Ac}{{A}_{a}} \times ( Nl - 1 ) ) , \qquad ( 3 )$$

In equation (3) Nl is the number of interface layers, which relates to the cassette depth, Lz using:

$$Lz = Nl \times dz + C , \qquad ( 4 )$$

where dz is the minimum distance between the interfaces of the layers required to allow for easy access and connectivity of the cassette and C a length parameter that comprises the additional length due to connector adapter form factors, additional space for further cassette functionalities, ergonomic factors, and other mechanical features of the device.

The derived equations indicate that for the multilayer interface with the opening concept, the new density (Eq. 2) and density gain (Eq. 3) depends not only on the front face area, Af of the cassette but also on the number of interface layers, Nl placed in the depth of the cassette 6. An interesting aspect of the invention is that the gained density does not depend on the area of the patch cable connector itself but only on the cross-section area of the cable. This is a consequence of the method used to engage to internal connectors of the cassette 6 which does not require the patch cable connector to pass through the opening, as it will be described in more detail herein.

Also, from the shown equations, when the cable cross-sectional area is significantly smaller than the adapter area, Aa>>Ac, G grows linearly as a function of the number of layers. Whereas, for comparable areas between cable cross-section and adapter, e.g., Ac/Ad≈l, there is no gain, G≈l since replacing adapters with large area openings does not provide any density improvement. For a very large number of layers, Nl>>2, the gain tends to a value of G≈Aa/Ac.

Therefore, the ratio of cable to connector adapters is a key element to enable density gains provided by the multilayer interface cassette 6 disclosed herein. The disclosed cassette modules may work in a structured cabling system where Ac<Aa. The smaller the ratio Ac/Aa, the higher the potential of this disclosure to increase connection or fiber density relative to the prior art. Recent advances in optical fiber cables, related to fibers with smaller diameters, e.g., 200-micron instead of 250-micron buffers, and multicore fibers, among others, align with that requirement, Ac/Aa<l and can produce significant gains in density beyond the ones obtained with current patch cords.

Since, in a multilayer interface with the opening, the total number of connectors depends not only on the front face but also on the depth and height of the cassette 6, another useful metric defined here is the density of connectivity per cassette volume, given by:

$$Dv = D / ( H \times Lz ) , \qquad ( 5 )$$

where H is the height of the cassette module.

Other metrics relevant for datacenter operators are the bandwidth per rack unit or RU (e.g., a RU height is 1.75 inches) for a given rack, such as the commonly used 19-inch wide rack. This density is given by:

$$Db = f \times B \times Nw \times Nm , \qquad ( 6 )$$

where B is the data rate per wavelength, Nw is the number of wavelengths, f is a factor of values one or two depending on if the link is unidirectional or bidirectional, and Nm is the number of modules that can be placed in one RU.

FIGS. 1A-1E and equations (1-5) indicate the multilayer interface design of the cassette 6, along with the feature of utilizing the opening 25 on the front case of the cassette to route patch cords 22, 24 into the internal housing of the cassette where the interfaces 11, 12, 13, and 14 are positioned in different layers, significantly increases the fiber optic connection density gain of the overall cassette 6 by utilizing the cassette depth, adding internal layers with interfaces, and allocating openings efficiently. For example, assuming the ratio of areas between a 3 mm cable and an LC duplex adapter as Ac/Aa=0.25, density gains values of G≈1.6 for Nl=2, and G≈2 for Nl=3 can be obtained. Better gains can be achieved using small-diameter cables, such as a 1.6 mm duplex patch cord. The larger Nl, the higher the density gain but also the larger the required depth Lz which is not a major constraint. Datacenter networks typically deploy 19-inch wide racks, with internal space (along the z-axis) mostly unused by passive devices. However, depending on Ac/Aa, Ao/Af, and dz a large Nl requires the area Ao of the opening 25 to be larger to accommodate a larger number of patch cords 22, 24 which can reduce the accessibility to internal interface layers of the cassette 6.

The cassette 6 including the multilayer interface with the opening concept may increase the optical connection density as described above. Actual designs for practical deployment require further considerations discussed in the next embodiments which focus on Nl=2 and a specific range of values for the front face opening 25, given by, 0.8≤Ao/Af<0.33. That range of sizes for the opening 25 permits the passing of four, six, or eight, standard diameter patch cord cables, e.g., 4 mm or less diameter, to connect to an internal layer of adapters.

Important parameters considered are the assignation and isolation of module areas for routing internal fibers with a feasible curvature radius to minimize fiber losses. The geometry and dimension of those areas enable negligible losses using standard ITU G652.D fiber and ITU G657 A1/A2 fiber. Using fiber with better macro bending loss properties, such as an ITU G657 B3 can reduce the size of the areas assigned for that purpose.

The number of openings in the front face of the cassette 6, as well as their size, and their locations are important parameters to optimize the embodiments. Additional openings on the bottom surface of the cassette, the orientation of internal connectors including azimuth angle, α, and elevation or tilt angle relative to the cassette plane, ϑ are other important factors to consider for dz reduction.

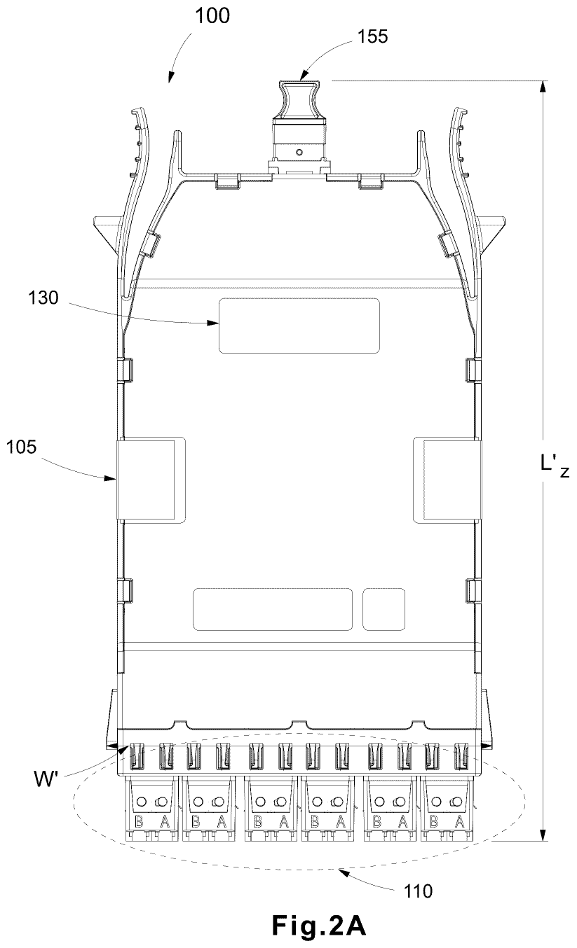

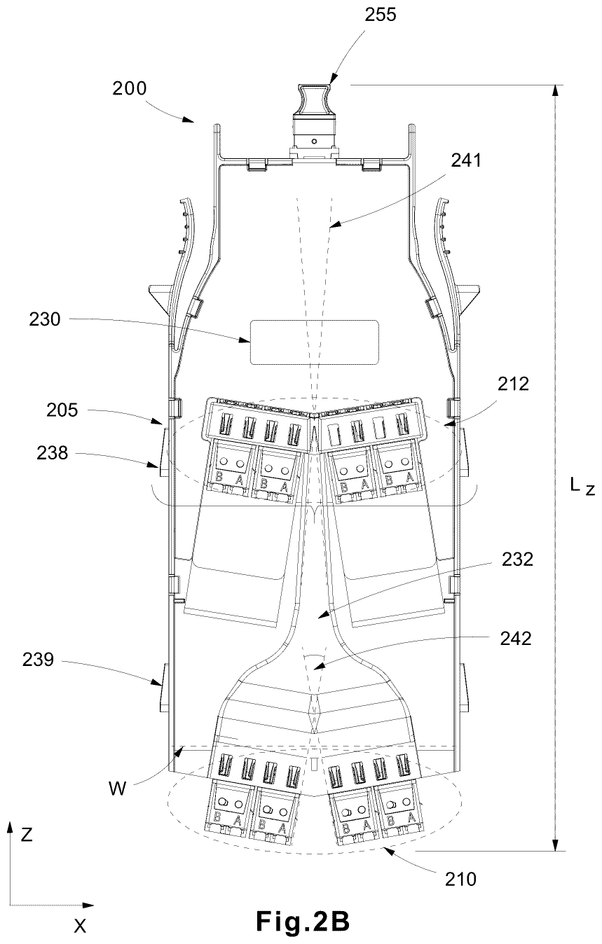

FIG. 2A shows a top-down view of a known cassette module 100, and FIG. 2B shows a top-down view of an exemplary cassette module 200 according to an embodiment of the present disclosure. Both have a main body and covers. Known cassette module 100 includes a main body 105 and a cover 130. The cassette module 200 includes a main body 205 and covers 230 and 232, which can be implemented together as one cover element. Both the known cassette module 100 and the present cassette module 200 can be installed in trays mounted in enclosures or patch panels as it will be described herein.

In this example, the known cassette module 100 includes one front face 110 with six LC duplex adapters. The cassette module 200 includes two interface layers, a first interface layer 210 on a front face of the cassette module 200, and a second interface layer 212 positioned internally within the cassette module 200, each with four LC duplex adapters. An angle 241 between groups of connectors in the second interface layer 212 facilitates access to the adapters. Also, an angle 242 can be used to facilitate the routing of internal fibers from adapters in the first interface layer 210 to the multi-fiber connector 255.

The cassette 200 including the multilayer interface with the opening modules may have two detent/positioning tabs 238, 239 per side, as shown in FIG. 2B. The functionality of the tab 238 is to provide a secondary position of the cassette 200 in a patch panel that is fully supported to allow the second row of adapters included in the second interface layer 212 to be accessible by a user. This provides the benefit of the cassette 200 being able to be held in place for easier access to the adapters in the second row comprising the second interface layer 212. The purpose of tab 239 is to position the cassette 200 into its detent position fully rearward in an enclosure or a patch panel.

Also, in this example, the known cassette module 100 and the cassette module 200 including the multilayer interface with the opening may have identical widths, W′=W. However, the cassette module 200 may have a larger depth, Lz≥L′z to accommodate the second interface layer 212 or additional functionality described later in this disclosure. As previously discussed, the increase in length along the cassette depth, the Z-axis in FIG. 2B, does not have any impact on connection density since that rearward space is currently unused in structured cabling systems.

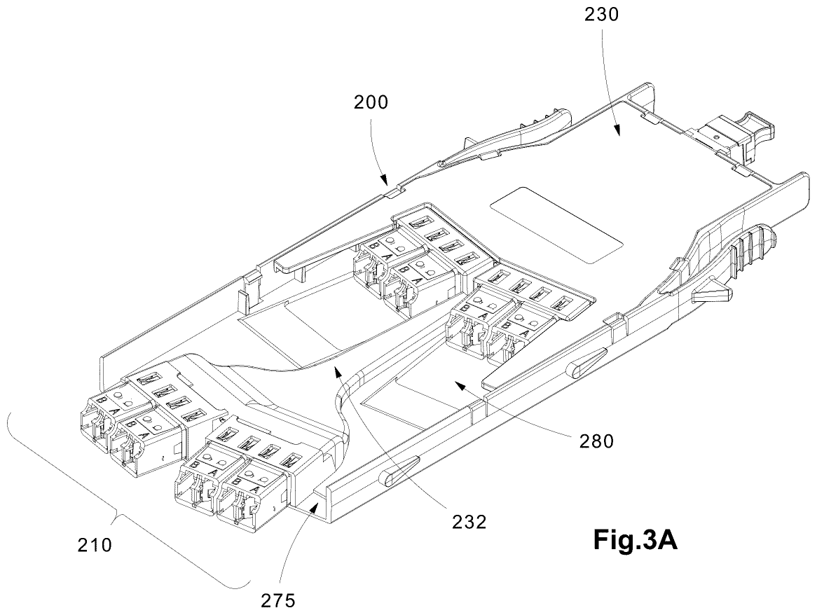

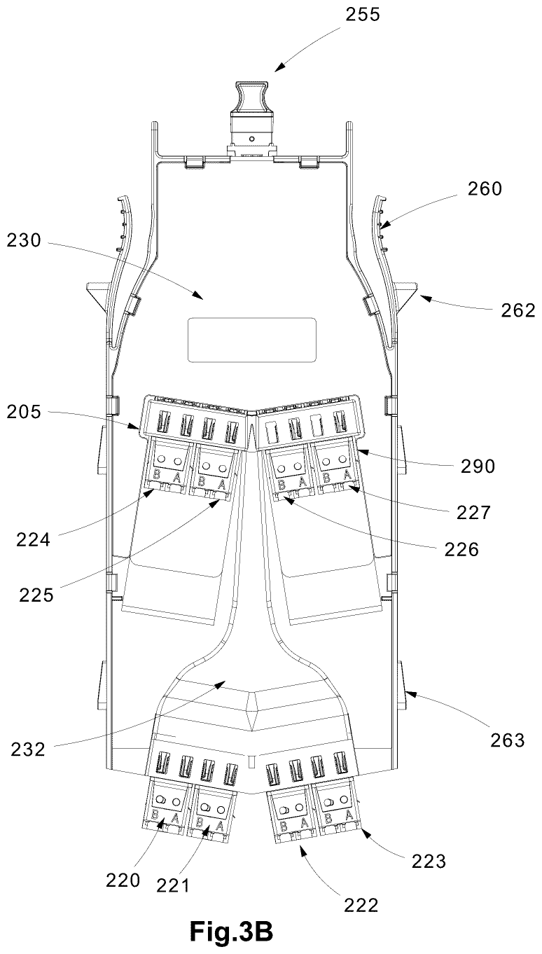

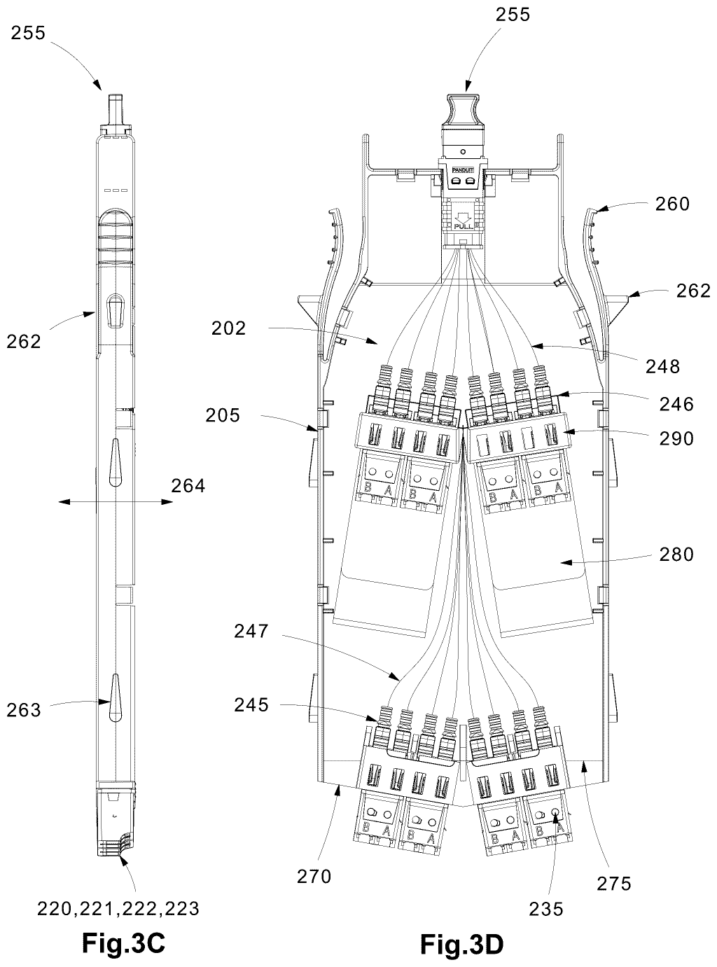

FIGS. 3A-3D show additional views of the cassette module 200. In FIGS. 3A and 3B, the cassette module 200 is shown with the covers 230 and 232. There are four optical adapters 220, 221, 222, and 223 included on the front face as part of the first interface layer 210. Four more adapters 224, 225, 226, and 227 are placed inside the cassette as part of the second interface layer 212. FIG. 3C shows the profile of the cassette module 200, where the height of the cassette module 200 is shown to be approximately ⅓ RU height. FIG. 3D shows the same view of the cassette 200 from FIG. 3B, but without including the covers 230 and 232.

Inside the main body 205 of the cassette module 200, there is a chamber 202 that contains part of the optical adapters and internal connectors 245, 246. Eight optical fibers 247 come out from the rear of the connector 245, and the optical fibers 247 are routed within the chamber 202 to connect to the multi-fiber connector 255 installed into the back on the cassette module 200. Eight optical fibers 248 come out the rear of the connector 246, and the optical fibers 248 are routed within the chamber 202 to connect to the multi-fiber connector 255 installed into the back of the cassette module 200. The number of optical fibers 247 shown in FIG. 3D are provided for exemplary purposes, as the number of optical fibers 247 in other embodiments may depend on the type of connector being used. For example, an embodiment of the cassette module 200 that uses SN connectors will at least increase the number of fibers by a factor of 3. In general, depending on the format type of the connectors 245, 246 used in the cassette module 200, the actual number of fibers utilized by the multi-fiber connector 255 may range from twelve, sixteen, twenty four, thirty two, or more fibers.

The cassette module 200 also includes flexible levers 260 and latches 262 at the rear. By pushing the levers 260, the latches 262 are disengaged, thus allowing the cassette module 200 to be removed from the rear of an enclosure of the patch panel. Note that the depth of the cassette module 200 may be shortened by using a shorter version of adapters such as junior style adapters and connectors. Connectors attached to the back of internal enclosed adapters such as LCs do not require boots at the rear, thus using less space. Those connectors do not have boots because they do not need to be accessed by the customer. Alternatively, depending on the application, optical circuits such as splitters, and taps, among others will require an increase in the cassette depth of the cassette module 200. In those embodiments, it is clearly understood that the levers 260 and latches 262 need to move, positioning them further near the end of the cassette module 200.

All the adapters 220, 221, 222, 223, 224, 225, 226, 227 included in the cassette module 200 may be removable. The adapters 220, 221, 222, 223, 224, 225, 226, 227 may have protrusions that engage with holes in the cassette module 200 at multiple positions (e.g., 16 positions) in the front face. Two openings 270 and 275 are positioned at opposite sides of the front face, as shown in FIG. 3D. The two openings 270, 275 serve as the entry points for the patch cords that connect to the second adapter layer 212 (i.e., second row of adapters). In this embodiment, the distance between the first adapter layer 210 (i.e., first row of adapters) to the second adapter layer 212, as shown in FIGS. 3B and 3D, may be in the range of 70 mm<dz≤125 mm. With these values, the cassette module 200 may have enhanced ergonomics, provide accessibility to the second layer of connectors, and satisfy mechanical strength criteria. This range of dz also enables the use of patch cords of similar lengths without producing significant slacks that are difficult to manage in a dense interconnection system. An important feature of the cassette module 200 is the open section 280, on the bottom surface and pivotable holder 290 to facilitate handling of the connectors as described later in this disclosure.

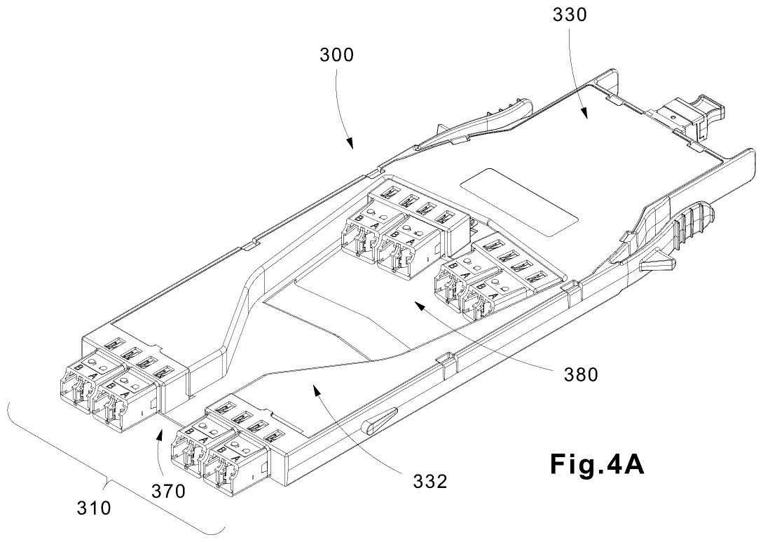

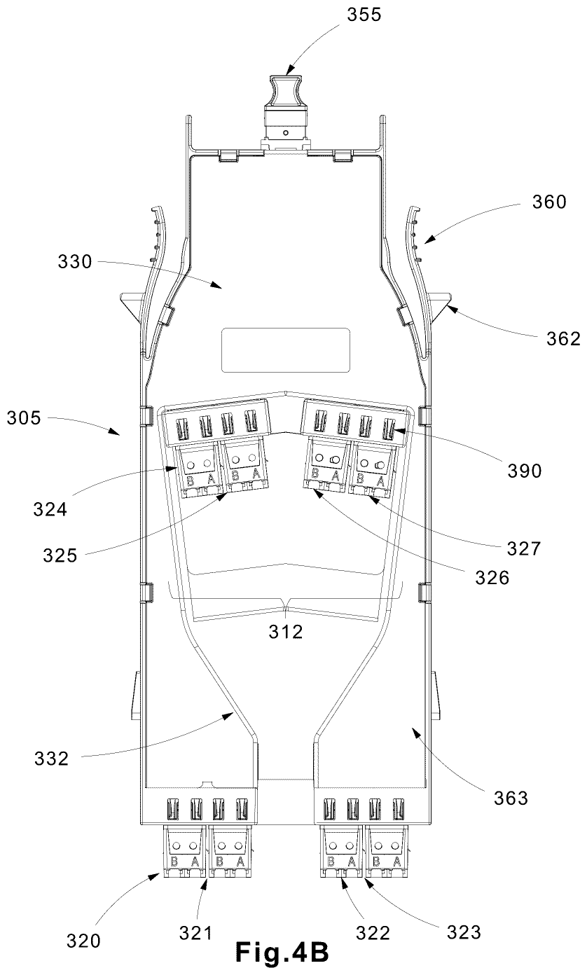

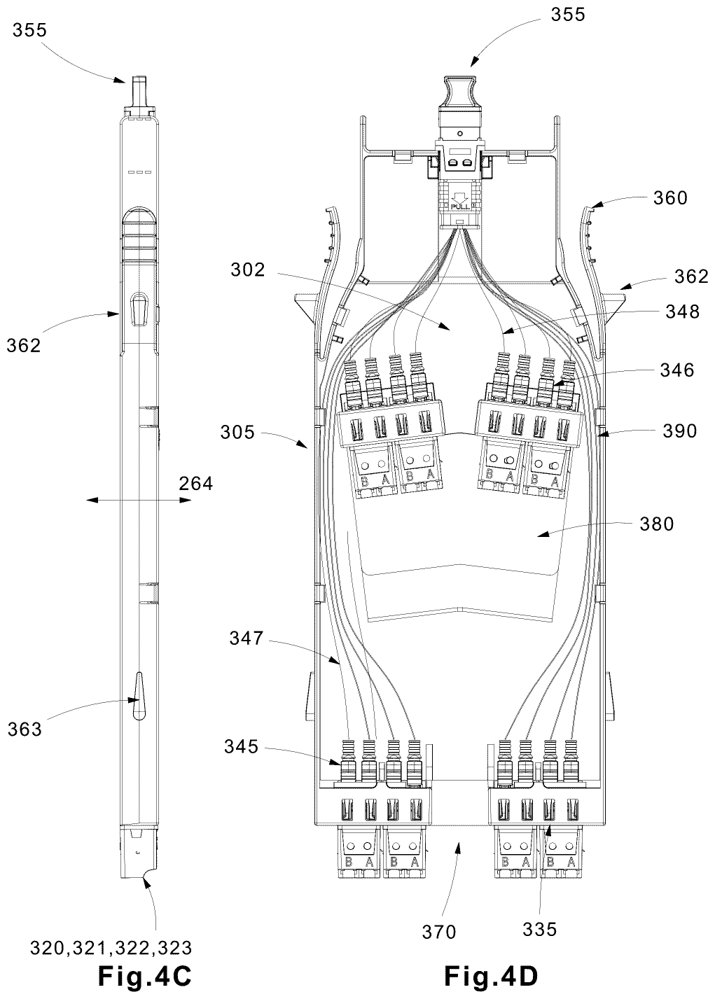

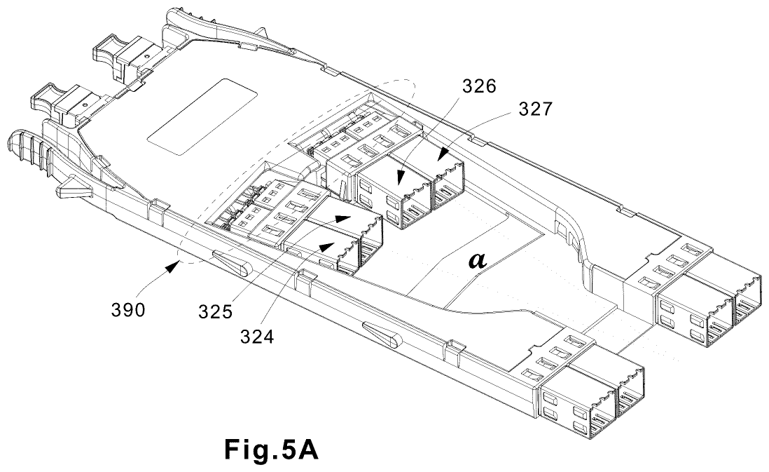

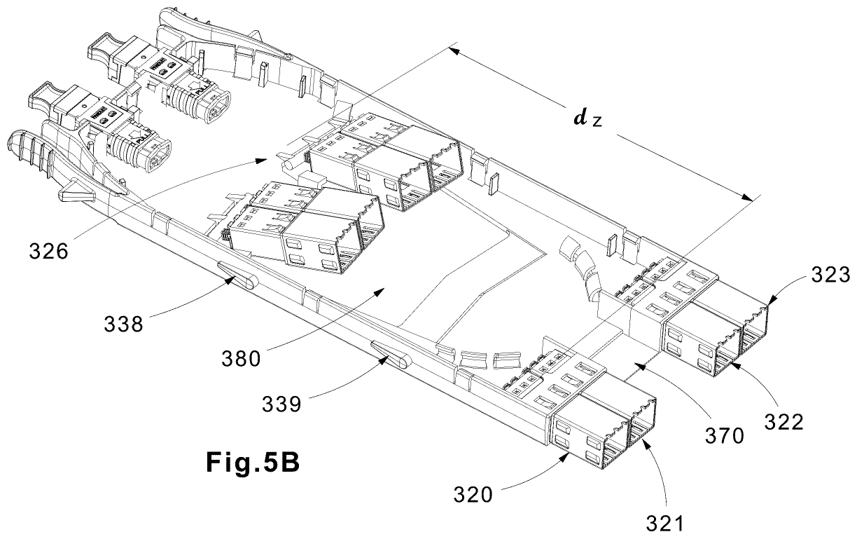

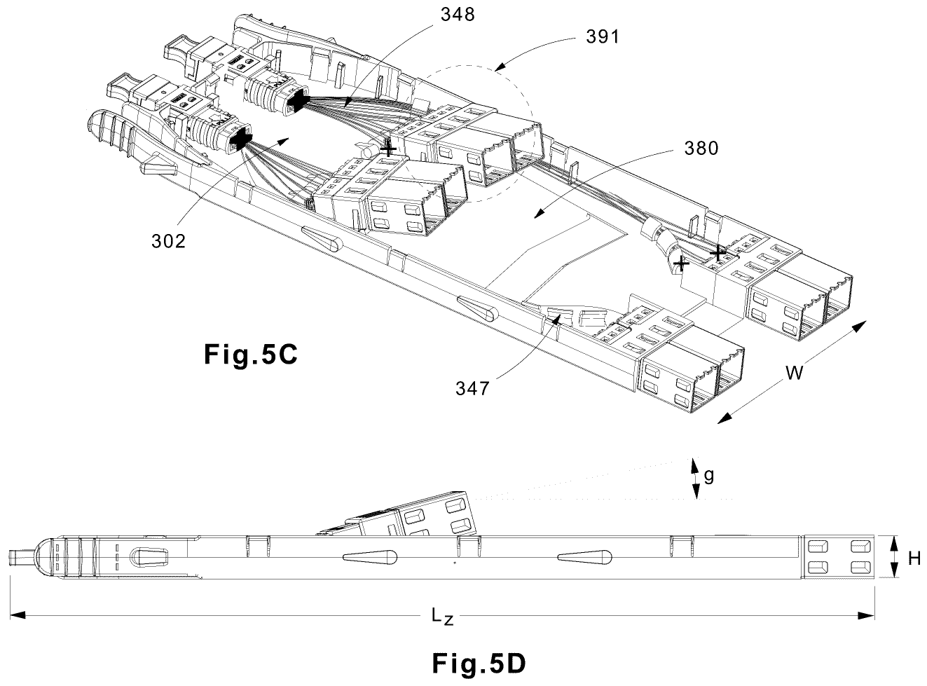

FIGS. 4A-4D show an exemplary cassette module 300 according to another embodiment. The cassette module 300 includes one opening 370 in the middle portion of a front face, instead of the two openings 270, 275 included in the cassette module 200. In FIG. 4A, the cassette module 300 is shown to include covers 330 and 332 which may be combined as one single cover according to some embodiments. There are four optical adapters 320, 321, 322, and 323 in the front face as part of a first interface layer 310. Four more adapters 324, 325, 326, and 327 are placed in a second interface layer 312 positioned within the cassette module 300, as shown in FIG. 4B. The four adapters 324, 325, 326, and 327 that are placed in the second interface layer 312 may be fixed such that they do not provide for any rotation. Or alternatively, the four adapters 324, 325, 326, and 327 that are placed in the second interface layer 312 may be rotatable, as described in more detail related to FIG. 5A.

FIG. 4C shows a profile of the cassette module 300, where the height of the cassette module 300 may be approximately ≈⅓ RU height. FIG. 4D shows the same cassette module 300 as shown in FIG. 4B, without including the covers 330 and 332.

Inside the main body 305 of the cassette module 300, there is a chamber 302 that provides space for a section of the optical adapters and internal connectors 345, 346. In other embodiments, that space of similar size or expanded width or depth can be used to accommodate a variety of additional optical or electrical circuits to add functionality to the cassette. For example, shuffle fiber fanouts, optical splitters, optical taps, or other types of optical fiber or optical integrated devices may be included here within the chamber 302 of the cassette module 300.

Eight optical fibers 347 connect the internal connector 345 to the multi-fiber connector 355 placed back on a back wall of the cassette module 300. Eight optical fibers 348 connect the internal connectors 346 to another eight fibers of the multi-fiber connector 355 on the back wall of the cassette module 300. The number of fiber connections supported by the cassette module 300, as evidenced by the fiber connection capacity of the multi-fiber connector 355 on the back wall of the cassette module 300, may vary depending on the type of connector used. For example, an embodiment of the cassette module 300 using SN connectors will at least increase the number of fibers by a factor of 3. In general, depending on the number of fibers used, the multi-fiber connector 355 may be representative of one or more multifiber connectors including twelve, sixteen, twenty four, thirty two, or more fibers connections.

The cassette module 300 also includes levers 360 placed on opposite sides of the cassette module 300 to facilitate its removal. By pushing the levers 360, the latches 362 that are included on the levers 360, are disengaged. Additional latches may be placed to better control the cassette displacement relative to an enclosure and to facilitate access to the internal connections at the adapters 324, 325, 326, and 327. All the adapters 320, 321, 322, 323, 324, 325, 326, 327 may be removable. The adapters 320, 321, 322, 323, 324, 325, 326, 327 include protrusions that engage with holes in the cassette module 300 at multiple positions (e.g., 16 positions) in the front face of the cassette module 300. One opening 370 in the front face provides the sole entry points of the patch cords that connect to the second interface layer 312 inside the cassette module 300.

In this embodiment shown for the cassette module 300, the distance between the first interface layer 310 to the second interface layer 312 is in the range of 70 mm<dz≤125 mm. This range may enhance ergonomics, provide better accessibility to the second layer of connectors, and satisfy mechanical strength criteria. Also, this range of dz enables the use of patch cords of similar lengths without producing significant slacks that are difficult to manage in a dense interconnection system.

As described, embodiments of the cassette module 200 and the cassette module 300 may include an opening section 280 and 380, respectively, on a bottom surface of the cassettes. The opening section 280 and 380 is a feature that provides more space for the installer to manipulate the connectors during the connection or disconnection of the patch cords to the internal adapters included in the second interface layer 212, 312. These adapters included in the second interface layer 212, 312 may also have a determined angular orientation relative to a vector normal to the front face opening(s) and relative to the surface of the cassette modules 200, 300.

FIGS. 5A-5D show the cassette module 300 to better emphasize and describe these features relating to the opening section 380, as well as the rotatable feature of the adapters 325, 324, 336, and 327 that enable them to tilt upwards for easier access to an installer. Furthermore, the cassette module 300 has been modified to now include SN type of adapters for the adapters 325, 324, 336, and 327, whereas in FIGS. 4A-4D the adapters 325, 324, 336, and 327 were shown to be LC type adapters. This further highlights the interoperability of the cassette module 300 to operate across different adapter/connector types.

FIG. 5A shows the parameter a, defined previously to indicate the connector orientation, here denoting half the angle between two groups of duplex connectors {325, 324} and {336, 327}. Each group of connectors is tilted ±α relative to a vector perpendicular to the front face opening of the cassette.

FIGS. 5B and 5C shows the adapters 325, 324, 336, and 327 with a tilt ϑ relative to the cassette bottom surface. As shown in FIG. 5C, this tilt is enabled by the pivotable mechanism 390 and the opening section 380 and provides additional space for the fingers of the operator and facilitates engagement of the patch cord connectors to the internal adapters 325, 324, 336, and 327 with connectors from the patch cords. To provide benefits during the mating of patch cords connector to internal adapters included in the second interface layer 312, the opening section 380 is located near the internal adapters 325, 324, 336, and 327 and has an opening size that allows the operator's fingers to manipulate the adapters/connectors. The total area of the opening section 380 is referenced as Ab, where Ab is at least Ab>8×Wa, (square millimeters) per internal adapter. In practice, Ab may be Ab≥80 square millimeters per internal adapter. All the elements described above facilitate access to the adapters included in the second interface layer 312 positioned internally within the cassette module 300 and allow the optimization of dz in the range specified previously.

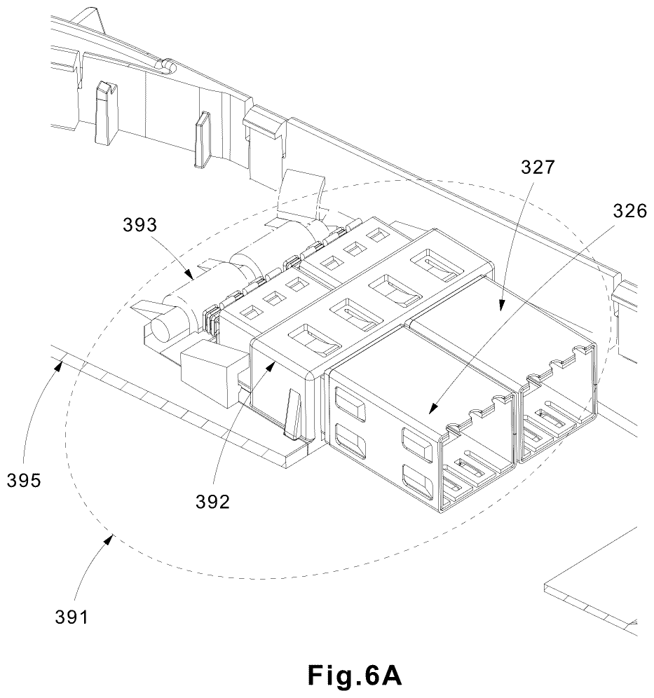

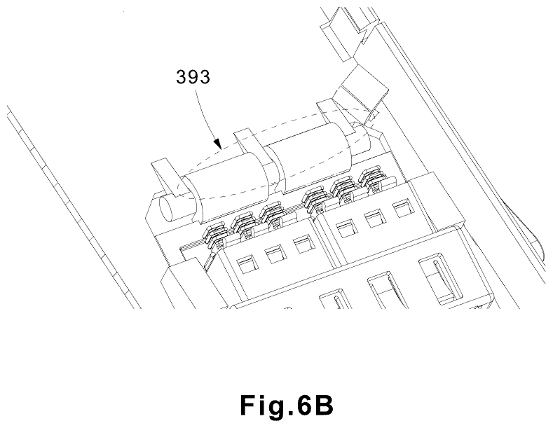

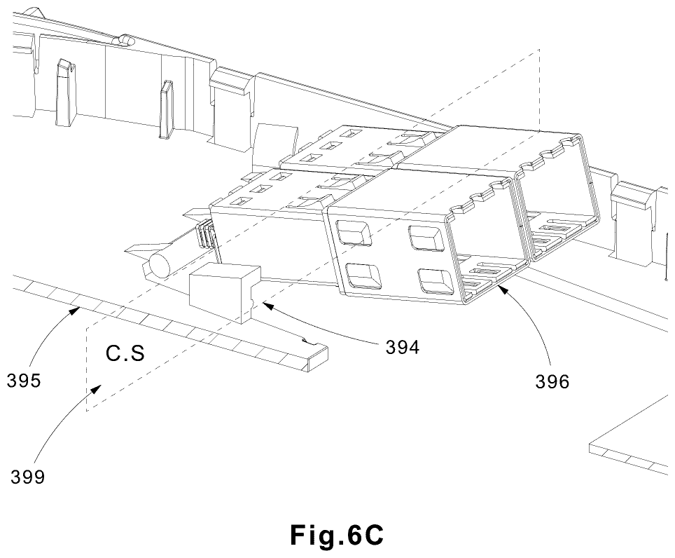

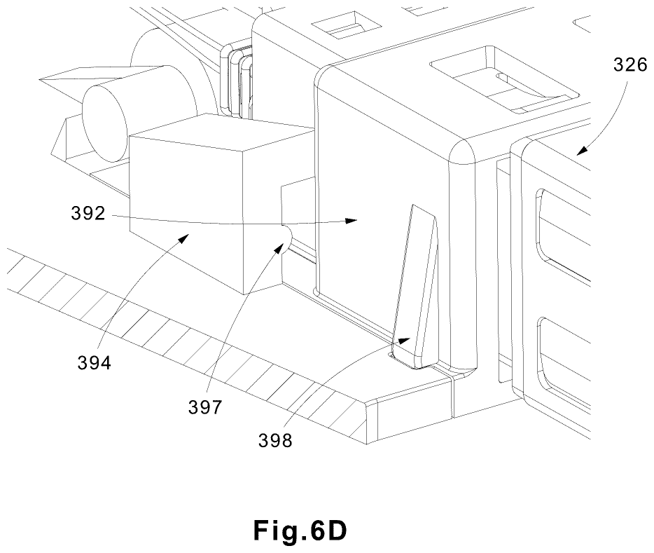

In FIG. 5C, the section 391 is a portion of the pivotable mechanism 390 that enables the rotation of two of the four internal adapters 326, 327 and the corresponding internal connector, relative to the cassette bottom surface 395, as will be described in more detail will reference to FIG. 6.

FIG. 6A shows details of section 391 of the pivotable mechanism 390 that enables the rotation of adapters 326 and 327 relative to the cassette bottom surface 395 of the cassette module 300. The pivotable mechanism 390 comprises two sections: a first section 391 is shown in the figure to rotate adapters 326 and 327, and a second section (not illustrated) for adapters 324, and 325. The section 391 comprises a hinge 393 (see, FIG. 6B) connected to a rotatable planar surface 396. The hinge 393 can rotate upwards tilting the planar surface 396. The section 391 also comprises carriages 392 that surround adapters 326 and 327. As shown in the magnified views of FIGS. 6C and 6D, a latch feature 394 connected to the cassette bottom surface 395, has a bump feature 397 that holds the planar surface 396 in the upward position associated with a determined angle. Therefore, the planar surface 396 which supports the carriages 392 and adapters 326 and 327, and back connectors, can be rotated and maintained at a defined angle relative to the cassette bottom surface 395. The bump feature 397 also holds the planar surface 396 in the downward position, preventing it from unintentionally traversing upwards.

As shown in the magnified view of FIG. 6D, there are latch features 398 from the sides of the carriages 392 each having a flat face across the bottom that prevents the adapter module from rotating down beyond the cassette bottom surface 395.

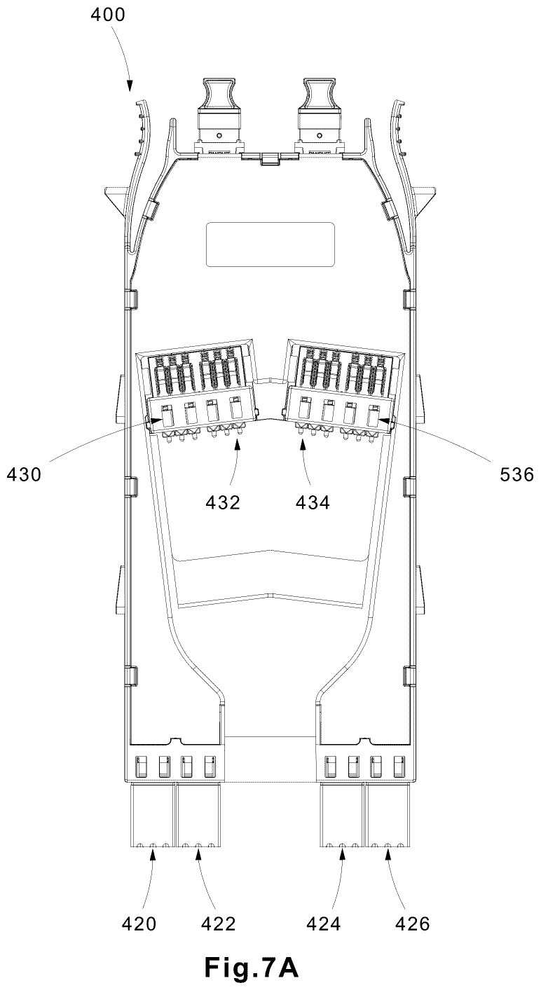

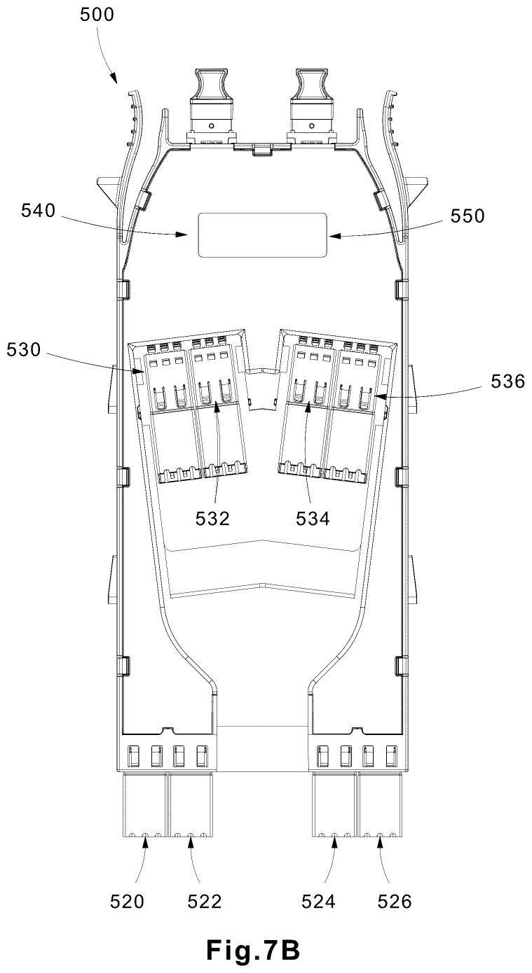

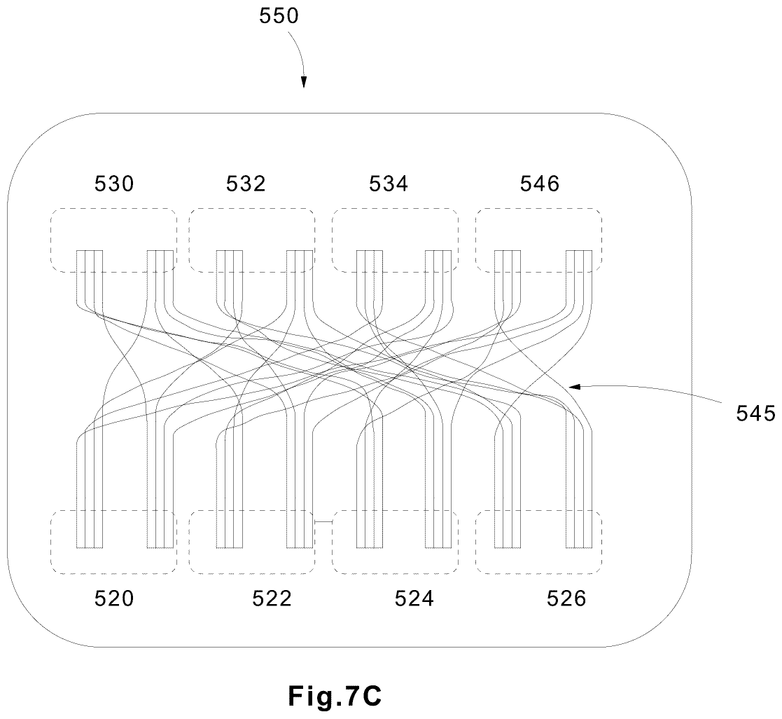

The density that can be achieved using the embodiments of the cassette module 200 and the cassette module 300 is at least 33% higher than the traditional one or 192 fibers per RU using LC duplex connectivity. This number can be increased even further (e.g., three times more) using smaller form factor connectors. For example, FIG. 7A illustrates an exemplary cassette module 400 that is dimensionally similar to the cassette module 300 but uses smaller form factor SN connectors instead of LC connectors. The cassette module 400 can increase the number of fibers per module to 48 and enable 576 fibers per RU, four times more than a traditional cassette using LC. In another variant, the SN can be replaced.

Alternative multifiber connectors such as MT, MPO or MDC, and SN-MP connectors can be used for applications requiring high density. In particular, FIG. 7B illustrates an exemplary cassette module 500 which can be used for deploying spine and leaf networks. The embodiment connects multifiber external ports 520, 522, 524, and 526 to internal multifiber ports 530, 532, 534, and 536. The mapping uses an interconnection topology shown in FIG. 7C where each line 545 represents an optical fiber or waveguide embedded in an optical circuit 550. The optical circuit 550 is located in the cassette region 540.

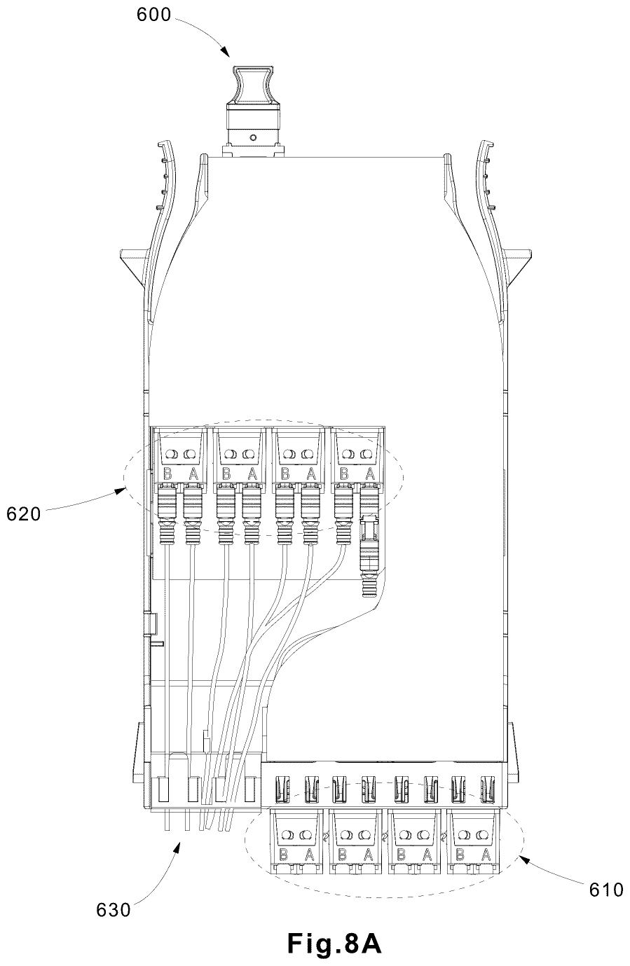

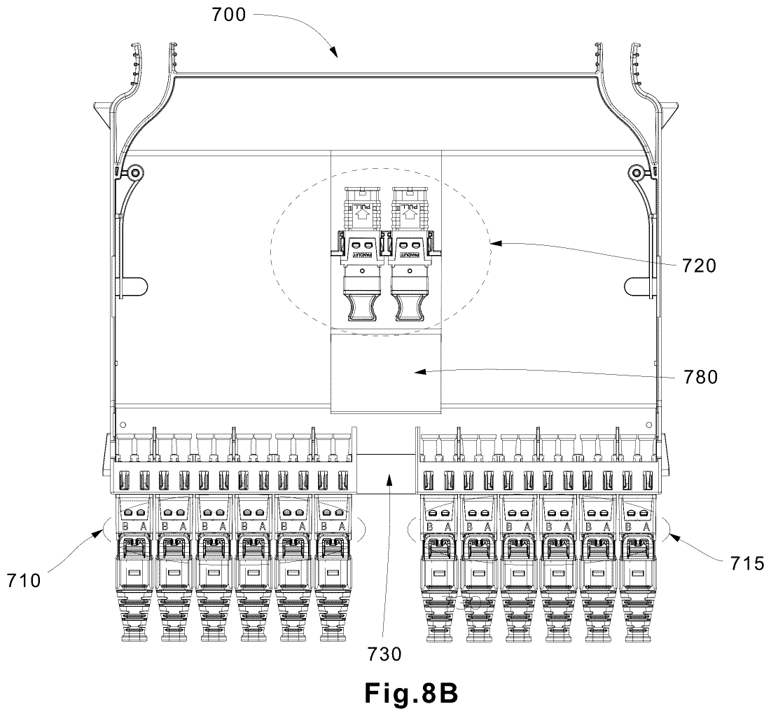

Also, the location of the front face opening and its area depends on the application. For some applications, it is convenient to have the opening on one side of the multilayer interface cassette. For example, FIG. 8A shows an exemplary cassette module 600 that includes two interface layers 610 and 620, and one opening 630 located on one side of the cassette module 600, to facilitate the connection with the internal second interface layer 620. As another example, if the second interface layer 620 contains multifiber/MPO connectivity, it may be advantageous to have incoming/ingress MPO patch cords (typically larger 3.0 mm diameter) routed to the left side of the enclosure (or patch panel) and the outgoing/egress LC (or SN) patch cords (typically smaller 1.6 mm/2 mm diameter) routed to the right side of the enclosure (or patch panel)—this may help to better organize and manage the patch cords during network cabling moves, adds or changes.

FIG. 8B shows another exemplary cassette module 700 that is configured for applications requiring high-density connections that can be accessed from the module front side 710 and 715, and internal multifiber adapters 720 which are accessed through opening 730 also on the front side of the cassette module 700. Therefore, this multilayer interface design concept may be applied to such “front access only” type of cassette modules 700 that may be used, for example, in optical frame distributions allowing for frequent changes of the external duplex connectivity at the module front side 710 and 715 for faster network reconfiguration while keeping access to multifiber interconnects 720 (e.g., adapters, or adapters with connectors installed when in an operational state), inside the modules, where these multifiber interconnects 720 inside of the cassette module 700 may be less frequently updated than those on the front face. The cassette module 700 may further include, for example, a removable floor portion 780 that, when removed, provides an opening for allowing finger access to the multifiber interconnects 720.

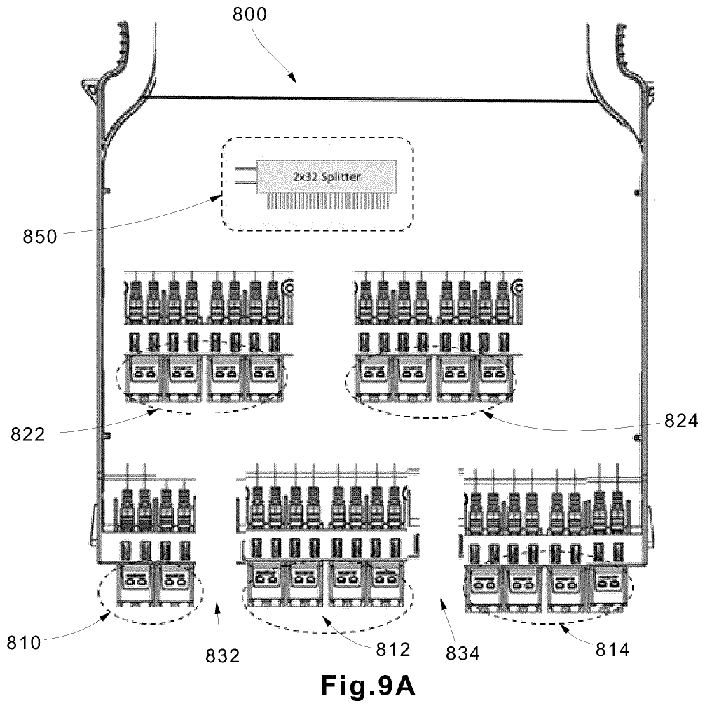

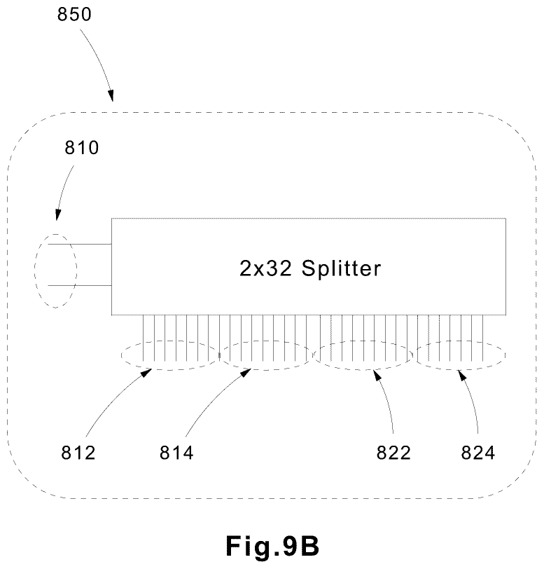

Multilayer interface cassettes with larger widths, as shown in the embodiment of the cassette module 700 can be useful for several applications such as Wave Division Multiplexing (WDM), optical taps, Passive Optical Networks (PON), or Passive Optical LAN (POL) devices. For example, FIG. 9A shows an exemplary cassette module 800 for PON or POL, according to some embodiments. In these embodiments, redundant LC inputs 810 connect to an Optical Line Terminator, OLT, and the LC ports 812, 814, 822, and 824 connect to the optical Network Terminators (ONTs). The openings 832 and 834 are used to route patch cords toward the internal group of adapters 822 and 824 respectively. For this disclosure, all connections may be bidirectional since transmitting signals and receiving signals propagate in opposite directions inside each fiber using different wavelengths. Inside the cassette, there is a photonic light circuit (PLC) 850. The PLC 850 may, for example, be a splitter (e.g., 2×32 splitter) as shown in FIG. 9B. As shown in FIG. 9B, the PLC 850 is configured to connect the inputs 810 to the outputs of the LC ports 812, 814, 822, and 824.

This cassette module 800 increases the front face density by 2× enabling six 2×32 PON splitter devices per RU. This density can be increased even more using small form factor connectors. For example, three times more density using SN-type connectors enables at least 2×64 PON in a similar cassette form factor. Similarly, an optical tap device using the multilayer interface concept disclosed here will produce a significant improvement in front-face density.

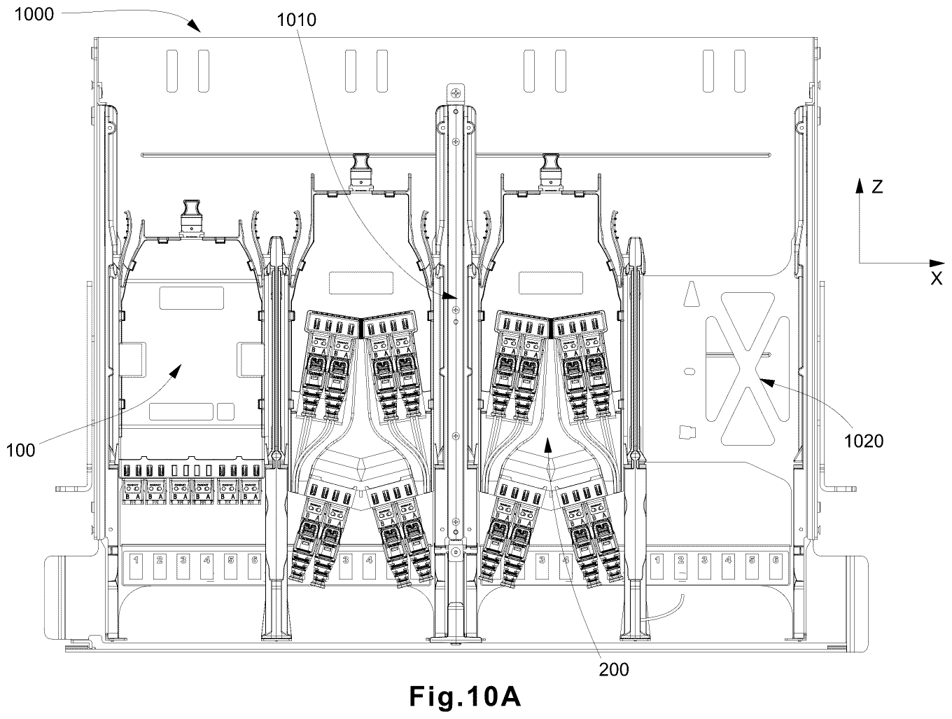

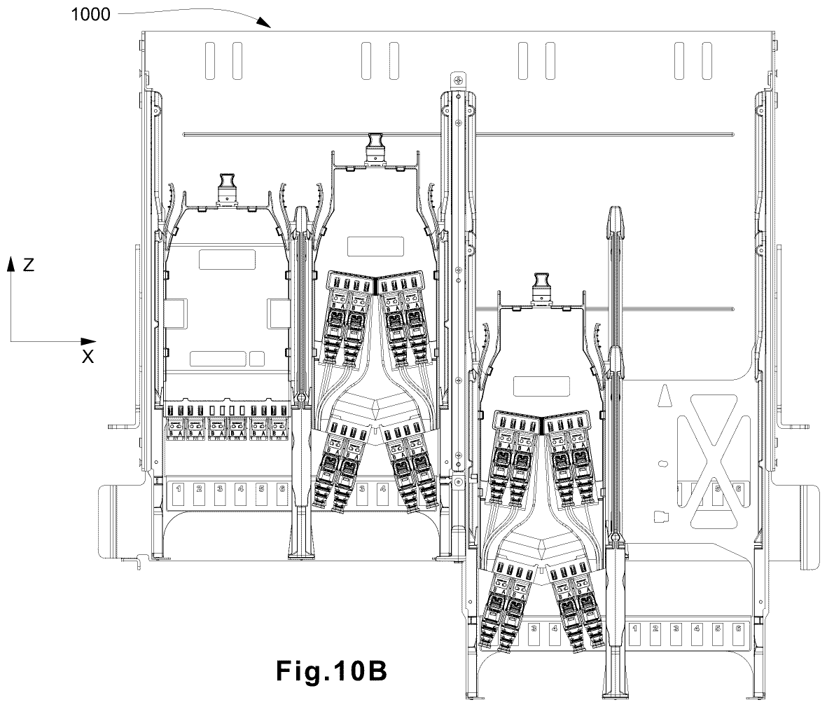

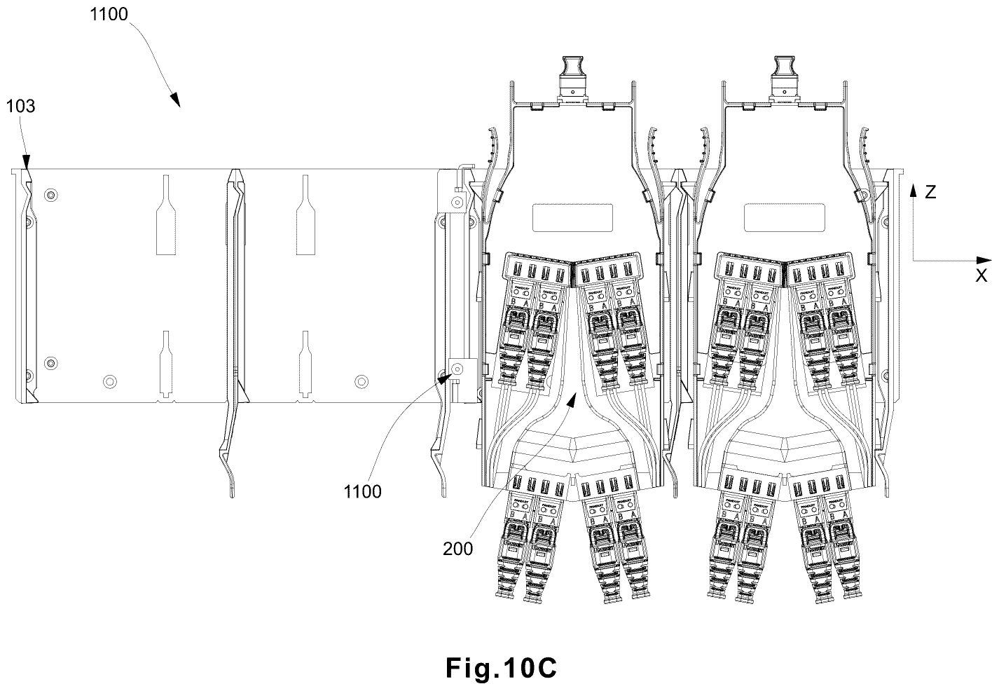

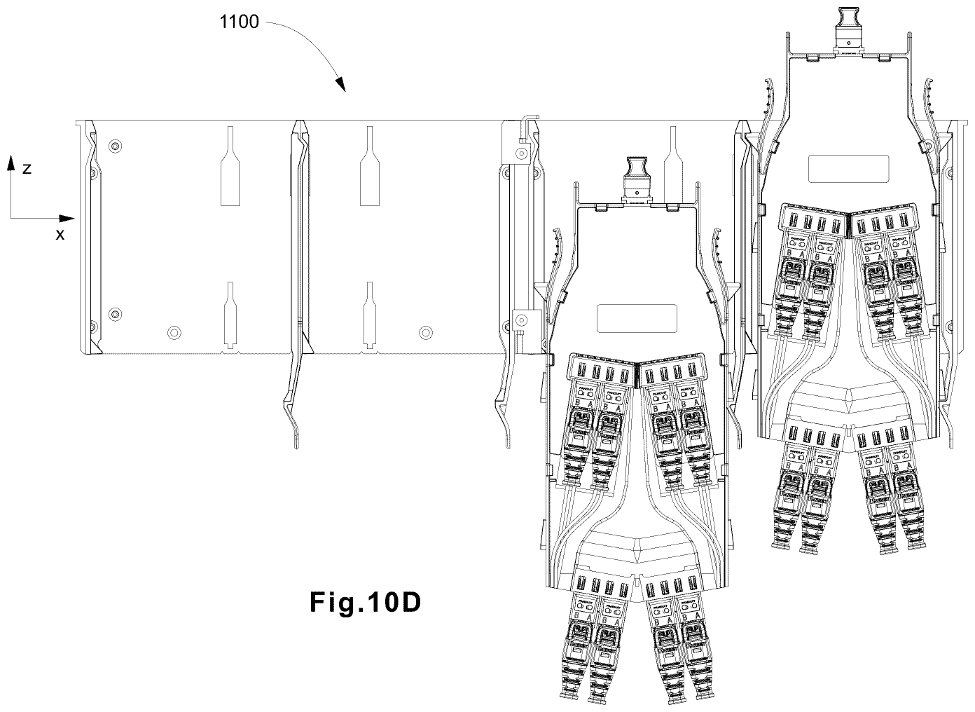

The disclosed embodiments can be utilized in patch panels or enclosures. The cassette modules can be produced in a variety of widths, enabling the deployment of two, four to eight modules per ⅓ RU height in a 19-inch width rack or wider ones. In the shown embodiments, the access to the external layer of interfaces is similar to traditional cassettes. However, to access the internal layer of connectors, the disclosed embodiments move cassettes from the internal space in the enclosure to expose the second array of connectors. To illustrate this, FIGS. 10A-10D show top-down views of an enclosure 1000 which may be used in a standard 19-inch width rack. The enclosure 1000 can accommodate a plurality of cassettes along its width. The enclosure 1000 has trays 1020 to support the cassettes. Typically, it is feasible to have two or more trays along the enclosure width and up to three levels of trays per RU. The enclosure has guiding rails to move two tray sections along the Z-axis. Other enclosures, not shown here, may have more guiding rails, e.g., 4, to enable the movement of each cassette independently. Here, the enclosure 1000 is partially populated with three cassettes, such as the known cassette module 100, and/or cassette module 200, where each are approximately 3.46 inches in width. So, the cassette module 200, as well as the other multilayer interface cassette modules described herein, include the dimensions as well as installation features to enable it to be installed into existing enclosures/trays and be mixed into systems that may include known cassette modules 100.

FIG. 10A shows a configuration state where all three cassettes 100, 200, 200 are inside the enclosure 1000. In this configuration, the internal adapters of the cassette module 200 are not tilted and aligned to the bottom surface of the cassette, ϑ=0. This desired condition occurs since there is no vertical space for the pivot mechanism 200 to allow the tilt of the adapters. To access the second interface layer of adapters, the tray supporting the cassette is moved along the Z-axis. When one of the cassettes 200 is moved forward enough, this will allow the adapters and connectors in the second interface layer 212 to be exposed (e.g., covers 230 and/or 232 are removable) and be accessible to the installer's hand and tilt to a convenient angle (e.g., using the tilt mechanism 390 shown in FIG. 4B) for convenient access to the connectors.

Alternatively, the tilt can be automatically provided by a more complex tilt mechanism 390 (not shown here but shown in FIG. 4B) which adjusts the tilt based on the displacement of the cassette, relative to the z-axis of the enclosure 1000.

FIG. 10A shows a configuration state where all three cassettes 100, 200, 200 are inside the enclosure. In this configuration, the internal adapters of embodiment 200 are untilted and aligned to the bottom surface of the cassettes 100, 200, 200, ϑ=0. This desired condition occurs since there is no vertical space for the pivot mechanism 200 to allow the tilt of the adapters. To access the second layer of adapters, the tray 1020 supporting the cassettes 100, 200, 200 is moved along the Z-axis. When one of the cassettes 100, 200, 200 moves enough to expose the tilt mechanism 390, the adapters and connectors in the second interface layer 212 are accessible to the installer's hand and tilt to a convenient angle for convenient access to the connectors.

Alternatively, the tilt can be automatically provided by a more complex mechanism 390 (not shown here but shown in FIG. 4B) which adjusts the tilt based on the displacement of the cassette, relative to the z-axis of the enclosure 1000.

FIGS. 10C and 10D show the cassette module 200 installed into a patch panel 1100 type of cable management system, which offers different capabilities and features from the enclosure 1000. FIG. 10C shows the cassette module 200 in an installed state where the cassette modules 200 are secured/locked into a recessed position during an installed state on the patch panel 1100. Then in FIG. 10D, the cassette module 200 is shown in slid out to expose a second row of adapters/connectors in an installation state where an installer may want access to the second row of adapters/connectors for installation actions.

According to the disclosed embodiments, in addition to the dz range, other critical metrics to improve density and facilitate access to the internal connector are the ratio of opening and front face area, or width assuming equal H and the ratio of cassette length vs the used optimum dz. Some useful ratios that optimize density while maintaining ergonomics for the user are 1/12<Ao/Aff<1/4, H≥1/4 RU, and 2<Lz/Dz<3. The azimuth and elevation angles are given by, α≤60 deg., and ϑ<90. The gains relative to a traditional cassette, using the same type of connectors and adapters are 1.25≤G≤2 for a two-layer cassette (Nl=2).

The number of fibers per RU enabled by the multilayer interface with the opening embodiments indicates densities of at least 192 fibers per RU using an LC duplex connector, and 1536 fibers per RU using MPO-16.

The bandwidth density, from equation (6) enabled by the multilayer interface with the opening embodiment reaches the Petabit per second per RU range. Using B=200 Gbps per wavelength, and Nw=8 wavelengths (IEEE task force 802.3dj) it is possible to achieve 0.922 Pbps per RU using SN connectors and 2.457 Pbps per RU using MPO-16 connectors. For example, using 18 wavelengths from the CWDM grid and 200 Gbps per wavelength produce densities of 5.530 Pbps per RU.

According to an embodiment, a fiber optic cassette apparatus is provided, which comprises, a main body, a front face, a rear side, a left side, and a right side, with a front face of area Af, that accommodates Na connectors, and has one or more front face openings of total area Ao, with Nl−1 internal layer of optical interfaces, where Nl≥2 and where each layer comprises at least Na adapters or connectors of identical or dissimilar type, each connector with an average area≥Aa and with average Ma fibers, wherein the internal structure of the cassette provides access paths from the front face opening(s) to the internal layers, to patch cords that have an average cross-sectional area, Ac, where Ac/Aa<0.75, for Ac<5 mm, wherein the total area of the aperture is bounded to Na×Ac×(Nl−1)≤Ao<Af, wherein the density measured as the number of connectors or fibers per area Af can be improved by a factor G bounded to 1<G≤Nl/(1+Ac/A_a×(Nl−1)), and wherein the total number of fibers per cassette is given by Nf≥Nl×Na×Ma providing a fiber density of Nf/Af.

According to this fiber optic cassette, a plurality of fiber optic components optically connects one or more multifiber adapters/connectors in the rear end to internal layers of optical adapters/connector interfaces in the cassettes or to external adapters/connectors located in the front face of the cassette. According to this fiber optic cassette, the front face opening(s) are placed at the center of the cassettes, to facilitate access to internal adapters placed close to the center of the cassette. According to this fiber optic cassette, the front face opening(s) are placed at the side of the cassettes, to facilitate access to internal adapters located on the edge sides of the cassettes. According to this fiber optic cassette, the total area of the openings is between 8% to 33% of the total front face area of the cassette. According to this fiber optic cassette, at least two latches attached symmetrically located near the rear end of the cassette to facilitate removal from an enclosure. According to this fiber optic cassette, at least two sets of detent/positioning tabs across the sides of the cassette to provide a secondary cassette holding position in a patch panel for easier user access to multiple arrays of adapters in the cassette is also provided. According to this fiber optic cassette, a secondary cover that encloses/protects the internal fibers is also provided. According to this fiber optic cassette, a plurality of fiber optic components optically connects one or more multifiber adapters/connectors in the rear end to internal layers of optical adapters/connector interfaces in the cassettes or to external adapters/connectors located in the front face of the cassette. This fiber optic cassette may be installed in enclosures, providing at least two layers of connectors, one external accessible from the front face, others located in the internal part of the cassette, accessible by sliding tray of the enclosure. This fiber optic cassette may be installed in patch panels providing at least two layers of connectors, one external accessible from the front face, others located in the internal part of the cassette, accessible by sliding the cassette within rails of the patch panel. According to this fiber optic cassette, the distances between layers of optical interfaces, defined as dz, is bounded to the range, 70 mm<dz≤125 mm. This fiber optic cassette may include one or more openings located on the bottom surface of the cassette body, near the internal adapters, with opening surface areas at least 80 square millimeters per adapter, to facilitate mating from patch cords connectors to the internal adapters. According to this fiber optic cassette, an internal pivot mechanism allows the internal adapters to rotate relative to the cassette bottom surface, where the tilt angle range is between zero to 90 degrees. This fiber optic cassette, without the rear multifiber connectors, installed in a front panel or enclosure, where all connections to a plurality of optical cables are performed from one side of the panel or enclosure, the front face side, where the cassette external adapters are connected to internal adapters by means of internal optical circuits, consisting in a plurality of fibers or integrated photonics such as planar lightwave circuits. According to this fiber optic cassette, the fiber channels transmit bidirectional optical signals, such as ones used for passive optical LAN or distributed antenna systems. According to this fiber optic cassette, the external or internal adapters are oriented at different angles relative to a z vector axis, where the orientation angle, named here azimuth, is in the range of 0 to ±75 degrees. According to this fiber optic cassette, the number of adapters per layer is different to maximize the use of the internal space of the cassette. According to this fiber optic cassette, the adapters used in each layer are of a different type, e.g., LC, SN in layer 1, MPO and SN-MT in layer two, MDC in layer 3, and other combinations that can maximize the use of the internal space of the cassette or increase functionality. This fiber optic cassette provides splitter functionalities for passive optical networks or passive optical LAN, where external and internal adapters each with an average of Ma fibers, are interconnected by internal optical fiber and optical splitters planar lightwave circuits, to provide splitting ratios as large as {Nr to (Nl×Na×Ma−Nr)} per cassette where Nr is the number of redundant inputs, and to (Nl×Na×Ma−Nr) the splitting fibers. This fiber optic cassette provides optical tap functionalities for monitoring or security applications, where external and internal adapters, are interconnected by internal optical fiber and optical taps circuits, discrete taps or planar lightwave circuits, that split each channel in two, allowing up to (Nl×Na×Ma/2) taps per cassette, where Ma is the average number of fiber per adapter. This fiber optic cassette provides mux or demux functionalities for wavelength division multiplexing used in LAN or broadband access, distribution, metropolitan or transport networks, where external and internal adapters, are interconnected by internal optical fiber and optical circuits, using discrete optical thin film filter or integrated lightwave circuits, that separate or combine signal transmitted at different optical wavelengths, allowing up multiplexing or demultiplexing of up to (Nl×Na×Ma−1) per cassette, where Ma is the average number of fiber per adapter.

This fiber optic cassette may include two layers of adapters, whereby the cassette height is 0.46″, width is 3.47″ and depth is less than 9″, that utilizes LC connectivity supporting 16 fibers per cassette and fiber density of 192 fiber per RU. This fiber optic cassette apparatus may include two layers of adapters, whereby the cassette height is 0.46″, width is 3.47″ and depth is less than 9″, that utilizes SN connectivity supporting 48 fibers per cassette and fiber density of 576 fiber per RU. This fiber optic cassette may include two layers of adapters, whereby the cassette height is 0.46″, width is 3.47″ and depth is less than 9″, that utilizes MPO with 12 fibers, connectivity supporting 96 fibers per cassette and fiber density of 1152 fiber per RU. This fiber optic cassette may include two layers of adapters, whereby the cassette height is 0.46″, width is 3.47″ and depth is less than 9″, that utilizes MPO with 16 fibers, connectivity supporting 128 fibers per cassette and fiber density of 1536 fiber per RU. This fiber optic cassette may include two layers of adapters, whereby the cassette height is 0.46″, width is 3.47″ and depth is less than 9″, that utilizes multifiber connector, such as SN-MT or MDC types, supporting 384 fibers per cassette and fiber density of 4608 fiber per RU. This fiber optic cassette may include two layers of adapters, whereby the cassette height is 0.46″, width is 7.5″ and depth is less than 9″, that utilizes LC connectivity supporting 32 fibers per cassette and fiber density of 192 fiber per RU. This fiber optic cassette may include two layers of adapters, whereby the cassette height is 0.46″, width is 7.5″ and depth is less than 9″, that utilizes SN connectivity supporting 96 fibers per cassette and fiber density of 576 fiber per RU. This fiber optic cassette may include two layers of adapters, whereby the cassette height is 0.46″, width is 7.5″ and depth is less than 9″, that utilizes MPO with 12 fibers, connectivity supporting 192 fibers per cassette and fiber density of 1152 fiber per RU. This fiber optic cassette may include two layers of adapters, whereby the cassette height is 0.46″, width is 7.5″ and depth is less than 9″, that utilizes MPO with 16 fibers, connectivity supporting 256 fibers per cassette and fiber density of 1536 fiber per RU. This fiber optic cassette may include two layers of adapters, whereby the cassette height is 0.46″, width is 7.5″ and depth is less than 9″, that utilizes multifiber connector, such as SN-MT or MDC types, connectivity supporting 768 fibers per cassette and fiber density of 4608 fiber per RU.

This fiber optic structured cable system consisting of cassette apparatus may be installed in a patch panel or enclosure system, where each fiber or fiber pair transmit≥1 Terabit per second enabling traffic over optical fiber beyond a Petabit per second per RU.

According to another embodiment, a fiber optic cassette is provided, which comprises, a main body, a front face, a rear side, a left side, and a right side, wherein: the front face accommodates a multiplicity of connectors and has one or more front face openings, the cassette apparatus contains at least one internal layer of optical interfaces, each layer which contains at least one adapter or connector of identical or dissimilar type, the internal structure of the cassette provides access paths from the front face opening(s) to the internal layers for patch cords.

According to this fiber optic cassette the openings are located at the center, edge, or intermedium positions in the front face where the total area of the openings is between 8% to 33% of the total front face area of the cassette. This fiber optic cassette may further comprise at least two latches attached symmetrically located near the rear end of the cassette to facilitate removal from an enclosure. This fiber optic cassette may further contain at least two sets of detent/positioning tabs across the sides of the cassette to provide a secondary cassette holding position in a patch panel for easier user access to multiple arrays of adapters in the cassette. This fiber optic cassette may further include a secondary cover that encloses/protects the internal fibers. According to this fiber optic cassette, a plurality of fiber optic components optically connects one or more multifiber adapters/connectors in the rear end to internal layers of optical adapters/connector interfaces in the cassettes or to external adapters/connectors located in the front face of the cassette. This fiber optic cassette may be installed in enclosures, providing at least two layers of connectors, one external accessible from the front face, others located in the internal part of the cassette, accessible by sliding tray of the enclosure. This fiber optic cassette may be installed in patch panel providing at least two layers of connectors, one external accessible from the front face, others located in the internal part of the cassette, accessible by sliding the cassette within rails of the patch panel. According to this fiber optic cassette, the distances between layers of optical interfaces, defined as dz, is bounded to the range, 70 mm<dz≤125 mm. This fiber optic cassette may include one or more openings located on the bottom surface of the cassette body, near the internal adapters, with opening surface areas at least 80 square millimeters per adapter, to facilitate mating from patch cords connectors to the internal adapters. According to this fiber optic cassette, an internal pivot mechanism allows the internal adapters to rotate relative to the cassette bottom surface, where the tilt angle range is between zero to 90 degrees. According to this fiber optic cassette, without the rear multifiber connectors, installed in a front panel or enclosure, where all connections to a plurality of optical cables are performed from one side of the panel or enclosure, the front face side, where the cassette external adapters are connected to internal adapters by means of internal optical circuits, consisting in a plurality of fibers or integrated photonics such as planar lightwave circuits. According to this fiber optic cassette, the fiber channels may transmit bidirectional optical signals, such as ones used for passive optical LAN or distributed antenna systems. According to this fiber optic cassette, the external or internal adapters are oriented at different angles relative to a z vector axis, where the orientation angle, named here azimuth, is in the range of 0 to ±75 degrees. According to this fiber optic cassette, the type and or number of adapters per layer is different to maximize the use of the internal space of the cassette.

This fiber optic cassette provides splitter functionalities for passive optical networks or passive optical LAN, where external and internal adapters each with an average of Ma fibers, are interconnected by internal optical fiber and optical splitters planar lightwave circuits, to provide splitting ratios as large as {Nr to (Nl×Na×Ma−Nr)} per cassette where Nr is the number of redundant inputs, and to (Nl×Na×Ma−Nr) the splitting fibers. This fiber optic cassette provides optical tap functionalities for monitoring or security applications, where external and internal adapters, are interconnected by internal optical fiber and optical taps circuits, discrete taps or planar lightwave circuits, that split each channel in two, allowing up to (Nl×Na×Ma/2) taps per cassette, where Ma is the average number of fiber per adapter. This fiber optic cassette provides mux or demux functionalities for wavelength division multiplexing used in LAN or broadband access, distribution, metropolitan or transport networks, where external and internal adapters, are interconnected by internal optical fiber and optical circuits, using discrete optical thin film filter or integrated lightwave circuits, that separate or combine signal transmitted at different optical wavelengths, allowing up multiplexing or demultiplexing of up to (Nl×Na×Ma−1) per cassette, where Ma is the average number of fiber per adapter.

This fiber optic cassette may include two layers of adapters, whereby the cassette height is 0.46″, width is 3.47″ and depth is less than 9″, that utilizes LC connectivity supporting 16 fibers per cassette and fiber density of 192 fiber per RU. This fiber optic cassette may include two layers of adapters, whereby the cassette height is 0.46″, width is 3.47″ and depth is less than 9″, that utilizes SN connectivity supporting 48 fibers per cassette and fiber density of 576 fiber per RU. This fiber optic cassette may include two layers of adapters, whereby the cassette height is 0.46″, width is 3.47″ and depth is less than 9″, that utilizes MPO with 12 fibers, connectivity supporting 96 fibers per cassette and fiber density of 1152 fiber per RU. This fiber optic cassette may include two layers of adapters, whereby the cassette height is 0.46″, width is 3.47″ and depth is less than 9″, that utilizes MPO with 16 fibers, connectivity supporting 128 fibers per cassette and fiber density of 1536 fiber per RU. This fiber optic cassette may include two layers of adapters, whereby the cassette height is 0.46″, width is 3.47″ and depth is less than 9″, that utilizes multifiber connector, such as SN-MT or MDC types, supporting 384 fibers per cassette and fiber density of 4608 fiber per RU. This fiber optic cassette may include two layers of adapters, whereby the cassette height is 0.46″, width is 7.5″ and depth is less than 9″, that utilizes LC connectivity supporting 32 fibers per cassette and fiber density of 192 fiber per RU. This fiber optic cassette may include two layers of adapters, whereby the cassette height is 0.46″, width is 7.5″ and depth is less than 9″, that utilizes SN connectivity supporting 96 fibers per cassette and fiber density of 576 fiber per RU. This fiber optic cassette may include two layers of adapters, whereby the cassette height is 0.46″, width is 7.5″ and depth is less than 9″, that utilizes MPO with 12 fibers, connectivity supporting 192 fibers per cassette and fiber density of 1152 fiber per RU. This fiber optic cassette may include two layers of adapters, whereby the cassette height is 0.46″, width is 7.5″ and depth is less than 9″, that utilizes MPO with 16 fibers, connectivity supporting 256 fibers per cassette and fiber density of 1536 fiber per RU. This fiber optic cassette may include two layers of adapters, whereby the cassette height is 0.46″, width is 7.5″ and depth is less than 9″, that utilizes multifiber connector, such as SN-MT or MDC types, connectivity supporting 768 fibers per cassette and fiber density of 4608 fiber per RU.

This fiber optic cassette may be installed in a patch panel or enclosure system, where each fiber or fiber pair transmit≥1 Terabit per second enabling traffic over optical fiber beyond a Petabit per second per RU.

According to another embodiment, a fiber optic cassette is provided, which comprises, a main body, a front face, a rear side, a left side, and a right side with a front face of area Af, comprising two layers of optical interconnections, one external accessible from the front face of the module, and another internal, where the first layer accommodates Na1 connectors each with Ma1 fibers, and the second layer Na2 connectors each with Ma2 fibers, where the connectors can be of a similar or different type, and where the front face allocate space for one or two front face openings of total area Ao, wherein the internal structure of the cassette provides access paths from the front face opening(s) to the internal layers, to patch cords that have an average cross-sectional area, Ac, where Ac/Aa<0.5, wherein the total area of the aperture is bounded to Na2×Ac≤Ao<Af, wherein the density measured as the number of connectors or fibers per area Af can be improved by a factor G bounded to 1<G≤2/(1+Ac/A_a)), and where the total number of fibers per module Nf>Na1×Ma1+Na2×Ma2 providing a fiber density of Nf/Af, where the average distance between the first and second layer of adapters is in the range of 70 mm to 125 mm.

According to this fiber optic cassette, the openings are located at the center, edge, or intermedium positions in the front face where the total area of the openings is between 8% to 33% of the total front face area of the cassette. This fiber optic cassette may contain at least two sets of detent/positioning tabs across the sides of the cassette to provide a secondary cassette holding position in a patch panel for easier user access to multiple arrays of adapters in the cassette. This fiber optic cassette may include a secondary cover that encloses/protects the internal fibers. This fiber optic cassette may include a plurality of fiber optic components optically connects one or more multifiber adapters/connectors in the rear end to internal layers of optical adapters/connector interfaces in the cassettes or to external adapters/connectors located in the front face of the cassette. This fiber optic cassette may be installed in enclosures, where external adapters are accessible from the front face, and internal adapters are accessible by sliding tray of the enclosure. This fiber optic cassette may be installed in patch panel, where external adapters are accessible from the front face, and internal adapters are accessible by sliding the cassette within rails of the patch panel. According to this fiber optic cassette, the distances between layers of optical interfaces, defined as dz, is bounded to the range, 70 mm<dz≤125 mm. According to this fiber optic cassette, one or more openings located on the bottom surface of the cassette body, near the internal adapters, with opening surface areas at least 80 square millimeters per adapter, to facilitate mating from patch cords connectors to the internal adapters. This fiber optic cassette, where an internal pivot mechanism allows the internal adapters to rotate relative to the cassette bottom surface, where the tilt angle range is between zero to 90 degrees. This fiber optic cassette, without the rear multifiber connectors, may be installed in a front panel or enclosure, where all connections to a plurality of optical cables are performed from one side of the panel or enclosure, the front face side, where the cassette external adapters are connected to internal adapters by means of internal optical circuits, consisting in a plurality of fibers or integrated photonics such as planar lightwave circuits. This fiber optic cassette, where the external or internal adapters are oriented at different angles relative to a z vector axis, where the orientation angle, named here azimuth, is in the range of 0 to ±75 degrees. This fiber optic cassette, where the type and or number of adapters per layer is different to maximize the use of the internal space of the cassette. This fiber optic cassette, whereby the cassette height is 0.46″, width is 3.47″ and depth is less than 9″, that utilizes LC connectivity supporting 16 fibers per cassette and fiber density of 192 fiber per RU. This fiber optic cassette apparatus, whereby the cassette height is 0.46″, width is 3.47″ and depth is less than 9″, that utilizes SN connectivity supporting 48 fibers per cassette and fiber density of 576 fiber per RU. This fiber optic cassette apparatus, whereby the cassette height is 0.46″, width is 3.47″ and depth is less than 9″, that utilizes MPO with 12 fibers, connectivity supporting 96 fibers per cassette and fiber density of 1152 fiber per RU. This fiber optic cassette may include two layers of adapters, whereby the cassette height is 0.46″, width is 3.47″ and depth is less than 9″, that utilizes MPO with 16 fibers, connectivity supporting 128 fibers per cassette and fiber density of 1536 fiber per RU. This fiber optic cassette apparatus, whereby the cassette height is 0.46″, width is 3.47″ and depth is less than 9″, that utilizes multifiber connector, such as SN-MT or MDC types, supporting 384 fibers per cassette and fiber density of 4608 fiber per RU. This fiber optic cassette apparatus, whereby the cassette height is 0.46″, width is 7.5″ and depth is less than 9″, that utilizes LC connectivity supporting 32 fibers per cassette and fiber density of 192 fiber per RU. This fiber optic cassette may include two layers of adapters, whereby the cassette height is 0.46″, width is 7.5″ and depth is less than 9″, that utilizes SN connectivity supporting 96 fibers per cassette and fiber density of 576 fiber per RU. This fiber optic cassette, whereby the cassette height is 0.46″, width is 7.5″ and depth is less than 9″, that utilizes MPO with 12 fibers, connectivity supporting 192 fibers per cassette and fiber density of 1152 fiber per RU. This fiber optic cassette may include two layers of adapters, whereby the cassette height is 0.46″, width is 7.5″ and depth is less than 9″, that utilizes MPO with 16 fibers, connectivity supporting 256 fibers per cassette and fiber density of 1536 fiber per RU. This fiber optic cassette whereby the cassette height is 0.46″, width is 7.5″ and depth is less than 9″, that utilizes multifiber connector, such as SN-MT or MDC types, connectivity supporting 768 fibers per cassette and fiber density of 4608 fiber per RU.

This fiber optic cassette may provide splitter functionalities for passive optical networks or passive optical LAN, where external and internal adapters each with an average of Ma fibers, are interconnected by internal optical fiber and optical splitters planar lightwave circuits, to provide splitting ratios SR as large as {Nr to (2×Na×Ma−Nr)} per cassette where Nr=1 or 2, is the number of redundant inputs, and to (2×Na×Ma−Nr) the splitting fibers. This fiber optic cassette may provide optical tap functionalities for monitoring or security applications, where external and internal adapters, are interconnected by internal optical fiber and optical taps circuits, discrete taps or planar lightwave circuits, that split each channel in two, allowing up to (Na×Ma) taps per cassette, where Ma is the average number of fiber per adapter. This fiber optic cassette may provide mux or demux functionalities for Wavelength division multiplexing used in LAN or broadband access, distribution, metropolitan or transport networks, where external and internal adapters, are interconnected by internal optical fiber and optical circuits, using discrete optical thin film filter or integrated lightwave circuits, that separate or combine signal transmitted at different optical wavelengths, allowing up multiplexing or demultiplexing of up to (2×Na×Ma−1) per cassette, where Ma is the average number of fiber per adapter. This fiber optic cassette, where a mesh of optical circuits, fiber optics, or waveguides, connect at least one fiber of the Na1 front face ports to at least one fiber of all the Na2 internal ports, wherein by selecting the proper fiber of each front face port, light can be transmitted to any internal port, and where Na1×Ma1=Na2×Ma2.

According to another embodiment, a method and apparatus are provided for increasing interconnection density in optical networks using a fiber optic cassette, which comprises, a main body, a front face, a rear side, a left side, and a right side wherein: the front face accommodates a multiplicity of connectors and has one or more front face openings, the cassette apparatus contains at least one internal layer of optical interfaces, each layer which contains at least one adapter or connector of identical or dissimilar type, the minimum distance between two adjacent internal layers is 70 mn, the maximum distance between two adjacent internal layers is 125 mn, the cassette apparatus has one or more front face opening(s) for patch cords, the total area of the front openings is between 8% to 33% of the total front face area of the cassette, the internal structure of the cassette provides access paths from the front face opening(s) to the internal layers of adapters.

This fiber optic module further comprises at least two latches attached symmetrically located near the rear end of the cassette to facilitate removal from an enclosure. This cassette may contain at least two sets of detent/positioning tabs across the sides of the cassette to provide a secondary cassette holding position in a patch panel for easier user access to multiple arrays of adapters in the cassette. This fiber optic cassette may further include a secondary cover that encloses/protects the internal fibers. This fiber optic cassette may further include a plurality of fiber optic components optically connects one or more multifiber adapters/connectors in the rear end to internal layers of optical adapters/connector interfaces in the cassettes or to external adapters/connectors located in the front face of the cassette. This fiber optic cassette may be installed in enclosures, providing at least two layers of connectors, one external accessible from the front face, others located in the internal part of the cassette, accessible by sliding tray of the enclosure. This fiber optic cassette may be installed in patch panel providing at least two layers of connectors, one external accessible from the front face, others located in the internal part of the cassette, accessible by sliding the cassette within rails of the patch panel. This fiber optic cassette may include one or more openings located on the bottom surface of the cassette body, near the internal adapters, with opening surface areas at least 80 square millimeters per adapter, to facilitate mating from patch cords connectors to the internal adapters. This fiber optic cassette, where an internal pivot mechanism allows the internal adapters to rotate relative to the cassette bottom surface, where the tilt angle range is between zero to 90 degrees. This fiber optic cassette, without the rear multifiber connectors, may be installed in a front panel or enclosure, where all connections to a plurality of optical cables are performed from one side of the panel or enclosure, the front face side, where the cassette external adapters are connected to internal adapters by means of internal optical circuits, consisting in a plurality of fibers or integrated photonics such as planar lightwave circuits. According to this fiber optic cassette, the fiber channels may transmit bidirectional optical signals, such as ones used for passive optical LAN or distributed antenna systems. According to this fiber optic cassette, the external or internal adapters are oriented at different angles relative to a z vector axis, where the orientation angle, named here azimuth, is in the range of 0 to ±75 degrees. According to this fiber optic cassette, the type and or number of adapters per layer is different to maximize the use of the internal space of the cassette.

This fiber optic cassette may provide optical tap functionalities for monitoring or security applications, where external and internal adapters, are interconnected by internal optical fiber and optical taps circuits, discrete taps or planar lightwave circuits, that split each channel in two, allowing a large number of optical taps per cassette. This fiber optic cassette may provide optical multiplexing or demultiplexing functionalities for wavelength division multiplexing used in LAN or broadband access, distribution, metropolitan or transport networks, where external and internal adapters, are interconnected by internal optical fiber and optical circuits, using discrete optical thin film filter or integrated lightwave circuits, that separate or combine signal transmitted at different optical wavelengths, allowing up multiplexing or demultiplexing of up to 256 wavelengths per cassette.

Furthermore, while the particular embodiments described herein have been shown and described, it will be obvious to those skilled in the art that changes and modifications may be made without departing from the teachings of the features described herein. The matter set forth in the foregoing description and accompanying drawings is offered by way of illustration only and not as limitation. The scope of the different embodiments described herein are intended to be defined in the following claims when viewed in their proper perspective.

What is claimed is:

1. A fiber optic cassette comprising:
a front-side face including a first opening and a second opening, the first opening being a first size and the second opening being a second size;
a rear-side wall configured to include a rear opening configured to receive a multi-fiber adapter;
a first side wall;
a second side wall;
a bottom surface floor spanning between the first side wall and the second side wall;
a first row adapter configured to install into the first opening; and
a second row adapter positioned along a second row on the bottom surface floor.

2. The fiber optic cassette of claim 1, wherein the second size is different from the first size and the second opening is configured to be a pass-through opening.

3. The fiber optic cassette of claim 1, wherein the second opening is positioned at a middle portion of the front-side face.

4. The fiber optic cassette of claim 1, wherein the second opening is positioned adjacent to one of the first side wall or the second side wall.

5. The fiber optic cassette of claim 1, wherein the second size is larger than the first size.

6. The fiber optic cassette of claim 1, the front-side face further including a third opening being a third size that is equal to the second size, wherein the second opening is adjacent to the first side wall and the third opening is adjacent to the second side wall.

7. The fiber optic cassette of claim 1, further comprising:
a rotating member configured to hold the second row adapter and rotate the second row adapter to a non-zero angle with reference to the bottom surface floor.

8. The fiber optic cassette of claim 7, further comprising:
an additional second row adapter positioned along the second row on the bottom surface floor; and
a second rotating member configured to hold the additional second row adapter and rotate the additional second row adapter to a non-zero angle with reference to the bottom surface floor.

9. The fiber optic cassette of claim 1, further comprising a third row adapter positioned at a third row on the bottom surface floor, wherein the third row position is deeper along a depth of the fiber optic cassette than the second row position.

10. The fiber optic cassette of claim 9, further comprising:
a rotating member configured to hold the third row adapter and rotate the third row adapter to a non-zero angle with reference to the bottom surface floor.

11. The fiber optic cassette of claim 9, wherein a fiber optic connection capacity from adapters positioned along the second row and the third row on the bottom surface is greater than a fiber optic connection capacity of adapters installed onto the front-side face.

12. The fiber optic cassette of claim 1, further comprising:
a top cover configured to cover at least a portion of the fiber optic cassette above the bottom surface floor, including the second row adapter.

13. The fiber optic cassette of claim 1, wherein a fiber optic connection capacity from adapters positioned along the second row on the bottom surface is the same, or greater, than a fiber optic connection capacity of adapters installed onto the front-side face.

14. The fiber optic cassette of claim 1, wherein the fiber optic cassette provides a fiber optic connection capacity of at least 16 fiber optic connections, wherein at least twelve of the fiber optic cassettes are configured to be installable into a 1 RU space cable management system, translating to at least 192 fiber optic connections in the 1 RU space cable management system.

15. The fiber optic cassette of claim 1, wherein the fiber optic cassette provides a fiber optic connection capacity of at least 48 fiber optic connections, wherein at least twelve of the fiber optic cassettes are configured to be installable into a 1 RU space cable management system, translating to at least 576 fiber optic connections in the 1 RU space cable management system.

16. The fiber optic cassette of claim 1, wherein fibers coupled to the first row adapter and to the second row adapters are routed along the bottom surface floor and all coupled to the multi-fiber adapter installed on the rear-side wall.

17. A fiber optic cassette comprising:
a front-side face including a plurality of first openings and a second opening, each of the first openings being a first size and the second opening being a second size that is different from the first size;
a rear-side wall configured to include a rear opening configured to receive a multi-fiber adapter;
a first side wall;
a second side wall;
a bottom surface floor spanning between the first side wall and the second side wall;
a plurality of first row adapters configured to install into the plurality of first openings; and
a plurality of second row adapters positioned along a second row on the bottom surface floor.

18. The fiber optic cassette of claim 17, wherein the plurality of second row adapters are partitioned into at least a first group and a second group.

19. The fiber optic cassette of claim 17, wherein a fiber optic connection capacity from the plurality of second row adapters on the bottom surface is the same, or greater, than a fiber optic connection capacity of the plurality of first row adapters.

20. The fiber optic cassette of claim 17, wherein the fiber optic cassette provides a fiber optic connection capacity of at least 16 fiber optic connections, wherein at least twelve of the fiber optic cassettes are configured to be installable into a 1 RU space cable management system, translating to at least 192 fiber optic connections in the 1 RU space cable management system.
